(19) United States
(12) Patent Application Publication
(10) Pub. No.: US 2011/0164021 A1
(43) Pub. Date: Jul. 7, 2011

(54) DISPLAY DEVICE AND DRIVE CONTROL METHOD THEREOF

(76) Inventor: Yasuhiro Seto, Kanagawa-ken (JP)

(21) Appl. No.: 13/119,316

(22) PCT Filed: Jan. 22, 2010
(86) PCT No.: PCT/JP2010/051179

§ 371 Date: Mar. 16, 2011

(30) Foreign Application Priority Data
Jan. 30, 2009 (JP) 2009-019582

(51) Int. Cl. G09G 5/00; G09G 3/30

(52) U.S. Cl. 345/211; 345/76

(57) ABSTRACT

A predetermined voltage is set to a gate terminal of a drive transistor in each of pixel circuits in a predetermined pixel circuit row in a period of selecting a pixel circuit row that is different from the predetermined pixel circuit row before a period of selecting the predetermined pixel circuit. A parasitic capacitance of the light-emitting element in each of the pixel circuits in the predetermined pixel circuit row is charged based on the set predetermined voltage, and detection of a threshold voltage of the drive transistor in each of the pixel circuits is started. Detection is completed within the period of selecting the predetermined pixel circuit row, and drive voltage is set to the drive transistor in each of the pixel-circuits in the predetermined pixel circuit row.

### TECHNICAL FIELD

The present invention relates to a display device including a light-emitting element that is driven by using an active matrix method. Further, the present invention relates to a drive control method of the display device.

### BACKGROUND ART

Conventionally, display devices using light-emitting elements, such as an organic EL (electroluminescence) light-emitting element, were proposed, and application of the display devices to various fields, such as displays of TV's or mobile phones, were proposed.

Generally, the organic EL light-emitting elements are current-driven-type light-emitting elements. Therefore, unlike liquid crystal displays, an organic EL light-emitting element needs to include at least a selection transistor for selecting a pixel circuit to be driven, a capacitance element that stores charges corresponding to a display image, and a drive transistor for driving the organic EL light-emitting element (please refer to Japanese Unexamined Patent Publication No. 8(1996)-234683, for example).

Conventionally, transistors made of low-temperature poly-silicon or amorphous silicon were used as pixel circuits of active-matrix-type organic EL display devices.

The thin-film transistor made of low-temperature poly-silicon can achieve high mobility and stable threshold voltage, but the mobility is not uniform. Meanwhile, the thin-film transistor made of amorphous silicon can achieve uniform mobility, but the mobility is low and the threshold voltage changes as time passes.

The non-uniform mobility and the unstable threshold voltage, as described above, generate unevenness in display images. Therefore, Japanese Unexamined Patent Publication No. 2003-255856 proposes providing a diode-connection-type compensation circuit in a pixel circuit of an organic EL display device. However, the pixel circuit becomes complex by providing the compensation circuit. Further, the cost of production increases as the yield of production drops, and the aperture ratio becomes lower.

Therefore, instead of providing the diode-connection-type compensation circuit for compensating the threshold voltage, disclosed in Japanese Unexamined Patent Publication No. 2003-255856, methods for reducing the number of transistors in the organic EL light-emitting elements have been proposed in Japanese Unexamined Patent Publication No. 2003-271095 and Japanese Unexamined Patent Publication No. 2007-310311. In the methods, the number of transistors has been reduced by correcting a change in the threshold voltage Vth of the drive transistor by self-charging the parasitic capacitance of the organic EL light-emitting element by the drive transistor.

However, in the methods disclosed in Japanese Unexamined Patent Publication No. 2003-271095 and Japanese Unexamined Patent Publication No. 2007-310311, the lengths of reset time periods for resetting the pixel circuits and the lengths of program time periods for setting program voltage may be reduced by improving the characteristic of the drive transistors and the resistance of circuits. However, the time period that is necessary for detecting the threshold voltage depends on value Cd of the parasitic capacitance of the organic EL light-emitting element. Therefore, in actual display operations, a time period of selecting a pixel circuit row is substantially occupied by the time period of detecting the threshold voltage.

Further, the time period of selecting a line is determined by a display update cycle (frame cycle) and the number of scan lines. For example, when resolution is increased while a panel size is fixed, the time period of selecting a line becomes shorter. However, since the area of the organic EL light-emitting element decreases and value Cd of the parasitic capacitance decreases, even if the time period of detecting the threshold voltage becomes shorter, no problem arises.

In contrast, when the panel size is increased, the time period of selecting a line does not change. However, since the area of the organic EL light-emitting element increases and value Cd of the parasitic capacitance increases, a problem that the time period of detecting the threshold voltage becomes longer arises. Hence, in the aforementioned conventional techniques, it was difficult to increase the panel size.

### DISCLOSURE OF INVENTION

In view of the foregoing circumstances, it is an object of the present invention to provide a display device that can provide (allocate) a sufficient threshold voltage detection time period, even if value Cd of the parasitic capacitance of the organic EL light-emitting element is large and the time period of selecting a line is short. Further, it is another object of the present invention to provide a drive control method of the display device.

A drive control method of a display device according to the present invention is a drive control method of a display device that includes:

an active matrix substrate in which a multiplicity of pixel circuits are arranged, each of the multiplicity of pixel circuits having a light-emitting element, an N-type drive transistor for driving the light-emitting element by supplying drive current to the light-emitting element, and a source terminal of the N-type drive transistor being connected to an anode terminal of the light-emitting element, a capacitance element connected between a gate terminal and the source terminal of the N-type drive transistor, and a selection transistor for switching connection between the gate terminal of the N-type drive transistor and a data line through which a drive voltage to be supplied to the N-type drive transistor is set; and

a scan drive circuit that selects a pixel circuit row in which the pixel circuits are arranged in a direction perpendicular to the direction of the data line by sequentially switching pixel circuit rows and connects each of the pixel circuits in the selected pixel circuit row and the data line by turning on the selection transistors in the selected pixel circuit row, the method comprising the steps of:

setting a predetermined voltage to the gate terminal of the drive transistor in each of the pixel circuits in a predetermined pixel circuit row in a time period of selecting a pixel circuit row that is different from the predetermined pixel circuit row before a time period of selecting the predetermined pixel circuit row;

charging a parasitic capacitance of the light-emitting element in each of the pixel circuits in the predetermined pixel circuit row based on the set predetermined voltage, and starting detection of a threshold voltage of the drive transistor in each of the pixel circuits;

completing detection of the threshold voltage within the time period of selecting the predetermined pixel circuit row; and

setting the drive voltage to the drive transistor in each of the pixel circuits in the predetermined pixel circuit row.

In the drive control method of a display device of the present invention, the gate terminal of the drive transistor in each of the pixel circuits in the predetermined pixel circuit row may be connected to the data line by turning on the selection transistor in each of the pixel circuits in the predetermined pixel circuit row while the predetermined voltage is set to the data line in a time period from the start to the completion of detecting the threshold voltage in each of the pixel circuits in the predetermined pixel circuit row. Further, the gate terminal of the drive transistor in each of the pixel circuits in the predetermined pixel circuit row may be disconnected from the data line by turning off the selection transistor in each of the pixel circuits in the predetermined pixel circuit row while a drive voltage of a drive transistor in each of pixel circuits in the pixel circuit row that is different from the predetermined pixel circuit row is set to the data line in the time period from the start to the completion of detecting a threshold. voltage in each of the pixel circuits in the predetermined pixel circuit row.

Further, a constant voltage supply transistor for switching connection between the gate terminal of the drive transistor and a constant voltage source may be provided parallel to the selection transistor with respect to the gate terminal of the drive transistor in each of the pixel circuits. The selection transistor may be turned off and the constant voltage supply transistor may be turned on to set a constant voltage from the constant voltage source to the drive transistor in each of the pixel circuits in the predetermined pixel circuit row while the threshold voltage in the predetermined pixel circuit row is detected. Further, the constant voltage supply transistor may be turned off and the selection transistor may be turned on while the drive voltage is set to the drive transistor in each of the pixel circuits in the predetermined pixel circuit row.

A constant voltage supply transistor may be provided parallel to the selection transistor with respect to the gate terminal of the drive transistor in each of the pixel circuits. Further, a gate voltage storage capacitance element for supplying, through the constant voltage supply transistor, a constant voltage to the gate terminal of the drive transistor in each of the pixel circuits may be provided. The data line and the gate voltage storage capacitance element may be connected to the gate terminal of the drive transistor in each of the pixel circuits in the predetermined pixel circuit row by turning on the selection transistor and the constant voltage supply transistor, and after then, the threshold voltage in the predetermined pixel circuit row may be detected by turning off the selection transistor to disconnect the gate terminal of the drive transistor in each of the pixel circuits in the predetermined pixel circuit row from the data line and by keeping the constant voltage supply transistor in an ON state. Further, the constant voltage supply transistor may be turned off and the selection transistor maybe turned on while the drive voltage is set to the drive transistor in each of the pixel circuits in the predetermined pixel circuit row.

Further, a common scan line may be used as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

Further, the time period of detecting the threshold voltage in each of the pixel circuits in the predetermined pixel circuit row may be controlled by adjusting a time period of a reset operation performed on each of the pixel circuits before detecting the threshold voltage.

A display device of the present invention is a display device comprising:

an active matrix substrate in which a multiplicity of pixel circuits are arranged, each of the multiplicity of pixel circuits including a light-emitting element, an N-type drive transistor for driving the light-emitting element by supplying drive current to the light-emitting element, and a source terminal of the N-type drive transistor being connected to an anode terminal of the light-emitting element, a capacitance element connected between a gate terminal and the source terminal of the N-type drive transistor, and a selection transistor for switching connection between the gate terminal of the N-type drive transistor and a data line through which a drive voltage to be supplied to the N-type drive transistor is set;

a scan drive circuit that selects a pixel circuit row in which the pixel circuits are arranged in a direction perpendicular to the direction of the data line by sequentially switching pixel circuit rows and connects each of the pixel circuits in the selected pixel circuit row and the data line by turning on the selection transistors in the selected pixel circuit row;

a voltage setting unit that sets a predetermined voltage to the gate terminal of the drive transistor in each of the pixel circuits in a predetermined pixel circuit row in a time period of selecting a pixel circuit row that is different from the predetermined pixel circuit row before a time period of selecting the predetermined pixel circuit row;

a threshold voltage detection unit that charges a parasitic capacitance of the light-emitting element in each of the pixel circuits in the predetermined pixel circuit row based on the predetermined voltage that has been set by the voltage setting unit, and starts detection of a threshold voltage of the drive transistor in each of the pixel circuits, and completes detection of the threshold voltage within the time period of selecting the predetermined pixel circuit row; and

a drive voltage setting unit that sets the drive voltage to the drive transistor in each of the pixel circuits in the predetermined pixel circuit row after the threshold voltage detection unit has completed detection of the threshold voltage.

In the display device of the present invention, the threshold voltage detection unit may connect the gate terminal of the drive transistor in each of the pixel circuits in the predetermined pixel circuit row to the data line by turning on the selection transistor in each of the pixel circuits in the predetermined pixel circuit row while the predetermined voltage is set to the data line in a time period from the start to the completion of detecting the threshold voltage in each of the pixel circuits in the predetermined pixel circuit row. Further, the threshold voltage detection unit may disconnect the gate terminal of the drive transistor in each of the pixel circuits in the predetermined pixel circuit row from the data line by turning off the selection transistor in each of the pixel circuits in the predetermined pixel circuit row while a drive voltage of a drive transistor in each of pixel circuits in the pixel circuit row that is different from the predetermined pixel circuit row is set to the data line in the time period from the start to the completion of detecting a threshold voltage in each of the pixel circuits in the predetermined pixel circuit row.

The display device of the present invention may further include a constant voltage supply transistor for switching connection between the gate terminal of the drive transistor and a constant voltage source, the constant voltage supply transistor being provided parallel to the selection transistor with respect to the gate terminal of the drive transistor in each of the pixel circuits. Further, the threshold voltage detection unit may turn off the selection transistor and turn on the constant voltage supply transistor to set a constant voltage from the constant voltage source to the drive transistor in each of the pixel circuits in the predetermined pixel circuit row while the threshold voltage detection unit detects the threshold voltage in the predetermined pixel circuit row. Further, the drive voltage setting unit may turn off the constant voltage supply transistor and turn on the selection transistor while the drive voltage setting unit sets the drive voltage to the drive transistor in each of the pixel circuits in the predetermined pixel circuit row.

The display device of the present invention may further include:

a constant voltage supply transistor that is provided parallel to the selection transistor with respect to the gate terminal of the drive transistor in each of the pixel circuits; and

a gate voltage storage capacitance element for supplying, through the constant voltage supply transistor, a constant voltage to the gate terminal of the drive transistor in each of the pixel circuits is provided. The threshold voltage detection unit may connect the data line and the gate voltage storage capacitance element to the gate terminal of the drive transistor in each of the pixel circuits in the predetermined pixel circuit row by turning on the selection transistor and the constant voltage supply transistor. After then, the threshold voltage detection unit may detect the threshold voltage in the predetermined pixel circuit row by turning off the selection transistor to disconnect the gate terminal of the drive transistor in each of the pixel circuits in the predetermined pixel circuit row from the data line and by keeping the constant voltage supply transistor in an ON state. Further, the drive voltage setting unit may turn off the constant voltage supply transistor and turn on the selection transistor while the drive voltage setting unit sets the drive voltage to the drive transistor in each of the pixel circuits in the predetermined pixel circuit row.

Further, a common scan line may be provided as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

Further, the threshold voltage detection unit may control the time period of detecting the threshold voltage in each of the pixel circuits in the predetermined pixel circuit row by adjusting a time period of a reset operation performed on each of the pixel circuits before detecting the threshold voltage.

According to the display device of the present invention and the drive control method of the display device, a predetermined voltage is set to the gate terminal of the drive transistor in each of the pixel circuits in a predetermined pixel circuit row in a time period of selecting a pixel circuit row that is different from the predetermined pixel circuit row before a time period of selecting the predetermined pixel circuit row. Further, a parasitic capacitance of the light-emitting element in each of the pixel circuits in the predetermined pixel circuit row is charged based on the set predetermined voltage, and detection of a threshold voltage of the drive transistor in each of the pixel circuits is started. Further, detection of the threshold voltage is completed within the time period of selecting the predetermined pixel circuit row. After then, the drive voltage is set to the drive transistor in each of the pixel circuits in the predetermined pixel circuit row. Therefore, even if a large panel having a large number of pixels, which has a large value of parasitic capacitance in a light-emitting element and a short time period of selecting a line, is used, it is possible to provide a sufficient length of threshold voltage detection time period (in other words, allocate a sufficient length of time period to threshold voltage detection). Further, it is possible to obtain a high-quality display device that can display images without substantial unevenness.

### BRIEF DESCRIPTION OF DRAWINGS

FIG. 1 is a schematic diagram illustrating the configuration of an organic EL display device to which a display device according to a first embodiment of the present invention has been applied;

FIG. 2 is a diagram illustrating the structure of a pixel circuit of the organic EL display device to which the display device according to the first embodiment of the present invention has been applied;

FIG. 3 is a timing chart for explaining the action of the organic EL display device to which the display device according to the first embodiment of the present invention has been applied;

FIG. 4 is a diagram for explaining the action of a resetting operation of the organic EL display device to which the display device according to the first embodiment of the present invention has been applied;

FIG. 5 is a diagram for explaining the action of a charge operation of the organic EL display device to which the display device according to the first embodiment of the present invention has been applied;

FIG. 6 is a diagram for explaining the action of a gate open control operation of the organic EL display device to which the display device according to the first embodiment of the present invention has been applied;

FIG. 7 is a diagram for explaining the action of a threshold voltage detection operation of the organic EL display device to which the display device according to the first embodiment of the present invention has been applied;

FIG. 8 is a diagram for explaining the action of a drive voltage setting operation of the organic EL display device to which the display device according to the first embodiment of the present invention has been applied;

FIG. 9 is a diagram for explaining a light-emitting operation of the organic EL display device to which the display device according to the first embodiment of the present invention has been applied;

FIG. 10 is a diagram illustrating another structure of a pixel circuit of the organic EL display device to which the display device according to the first embodiment of the present invention has been applied;

FIG. 11 is a diagram for explaining a method for controlling the time period of an operation for detecting the threshold voltage by adjusting the time period of a reset operation;

FIG. 12 is a schematic diagram illustrating the configuration of an organic EL display device to which a display device according to a second or third embodiment of the present invention has been applied;

FIG. 13 is a diagram illustrating the structure of a pixel circuit of the organic EL display device to which the display device according to the second embodiment of the present invention has been applied;

FIG. 14 is a timing chart for explaining the action of the organic EL display device to which the display device according to the second embodiment of the present invention has been applied;

FIG. 15 is a diagram for explaining the action of a resetting operation of the organic EL display device to which the display device according to the second embodiment of the present invention has been applied;

FIG. 16 is a diagram for explaining the action of a charge operation of the organic EL display device to which the display device according to the second embodiment of the present invention has been applied;

FIG. 17 is a diagram for explaining the action of a threshold voltage detection operation of the organic EL display device to which the display device according to the second embodiment of the present invention has been applied;

FIG. 18 is a diagram for explaining the action of a drive voltage setting operation of the organic EL display device to which the display device according to the second embodiment of the present invention has been applied;

FIG. 19 is a diagram for explaining a light-emitting operation of the organic EL display device to which the display device according to the second embodiment of the present invention has been applied;

FIG. 20 is a diagram illustrating another structure of the pixel circuit of the organic EL display device to which the display device according to the second embodiment of the present invention has been applied;

FIG. 21 is a diagram illustrating a modification example of the organic EL display devices according to the second and third embodiments of the present invention;

FIG. 22 is a diagram illustrating the structure of a pixel circuit of the organic EL display device to which the display device according to the third embodiment of the present invention has been applied;

FIG. 23 is a timing chart for explaining the action of the organic EL display device to which the display device according to the third embodiment of the present invention has been applied;

FIG. 24 is a diagram for explaining the action of a resetting operation of the organic EL display device to which the display device according to the third embodiment of the present invention has been applied;

FIG. 25 is a diagram for explaining the action of a charge operation of the organic EL display device to which the display device according to the third embodiment of the present invention has been applied;

FIG. 26 is a diagram for explaining the action of a threshold voltage detection operation of the organic EL display device to which the display device according to the third embodiment of the present invention has been applied;

FIG. 27 is a diagram for explaining the action of a drive voltage setting operation of the organic EL display device to which the display device according to the third embodiment of the present invention has been applied;

FIG. 28 is a diagram for explaining a light-emitting operation of the organic EL display device to which the display device according to the third embodiment of the present invention has been applied;

FIG. 29 is a diagram illustrating another structure of a pixel circuit of the organic EL display device to which the display device according to the third embodiment of the present invention has been applied; and

FIG. 30 is a diagram for explaining the condition of the value of parasitic capacitance of the organic EL display device.

### BEST MODE FOR CARRYING OUT THE INVENTION

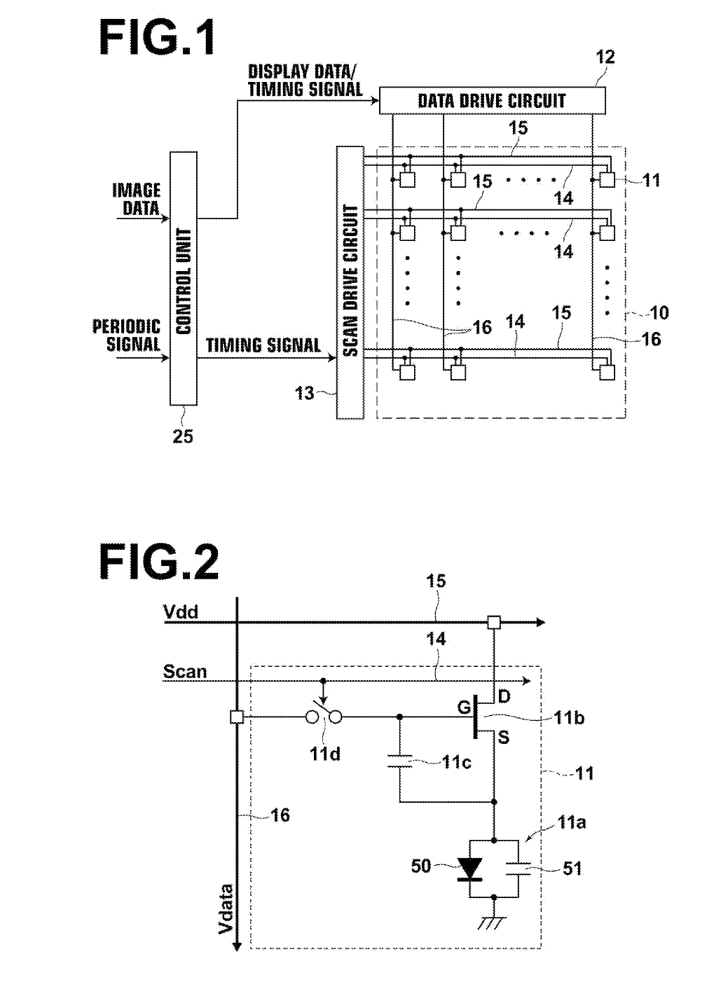

Hereinafter, an organic EL display device to which a display device according to a first embodiment of the present invention has been applied will be described with reference to drawings. FIG. 1 is a schematic diagram illustrating the configuration of an organic EL display device to which a display device according to the first embodiment of the present invention has been applied

As illustrated in FIG. 1, the organic EL display device of the present embodiment includes an active matrix substrate 10, a data drive circuit 12, a scan drive circuit 13, and a control unit 25. A multiplicity of pixel circuits 11, each including an organic EL light-emitting element, are two-dimensionally arranged in the active matrix substrate 10. The data drive circuit 12 supplies drive voltage, based on display data, to a gate terminal of a drive transistor in each of the pixel circuits 11. The scan drive circuit 13 outputs a scan signal to each of the pixel circuits 11, and the control unit 25 outputs display data corresponding to image data and a timing signal based on a synchronous signal to the data drive circuit 12.

Further, the active matrix substrate 10 includes a multiplicity of scan lines 14, a multiplicity of power source lines 15, and a multiplicity of data lines 16. The multiplicity of scan lines 14 send scan signals output from the scan drive circuit 13 to each pixel circuit row. The multiplicity of power source lines 15 supply variable voltage Vddn output from the scan drive circuit 13 to each pixel circuit row. The multiplicity of data lines 16 supply drive voltage output from the data drive circuit 12 to each pixel circuit column.

Further, the data lines 16, the scan lines 14, and the power source lines 15 are arranged in grid form in such a manner that the data lines 16 are perpendicular to both of the scan lines 14 and the power source lines 15. The pixel circuits 11 are provided in the vicinities of the intersections of these lines.

As illustrated in FIG. 2, each of the pixel circuits 11 includes an organic EL light-emitting element 11a, a drive transistor (a transistor for driving the organic EL light-emitting element 11a) 11b, a capacitance element 11c, and a selection transistor (a transistor for selecting) 11d. Source terminal S of the drive transistor 11b is connected to an anode terminal of the organic EL light-emitting element 11a, and the drive transistor 11b supplies drive current to the organic EL light-emitting element 11a. The capacitance element 11c is connected between the gate terminal G and the source terminal S of the drive transistor 11b. One of the ends of the selection transistor 11d is connected to both of an end of the capacitance element 11c and the gate terminal G of the drive transistor 11b. Further, the other end of the selection transistor 11d is connected to the data line 16.

The organic EL light-emitting element 11a includes a light-emitting unit (light output unit) 50 and a parasitic capacitance 51 of the light-emitting unit 50. The light-emitting unit 50 outputs light by the drive current supplied from the drive transistor 11b. A cathode terminal of the organic EL light-emitting element 11a is connected to a common potential (a ground potential in FIG. 2).

The drive transistor 11b and the selection transistor 11d are constituted by N-type thin-film transistors. Further, as the thin-film transistor for the drive transistor 11b, an amorphous-silicon thin-film transistor, an inorganic oxide thin-film transistor, or the like may be used. As the inorganic oxide thin-film transistor, for example, a thin-film transistor including an inorganic oxide thin-film made of IGZO (InGaZnO) may be used. The material of the inorganic oxide thin-film is not limited to IGZO, and IZO(InZnO) or the like may also be used.

The scan drive circuit 13 sequentially outputs, based on the timing signal output from the control unit 25, scan signal Scann for turning on/off the selection transistor 11d in each of the pixel circuits 11 to each of the scan lines 14. Further, the scan drive circuit 13 supplies variable voltage based on operation timing to each of the power source lines 15.

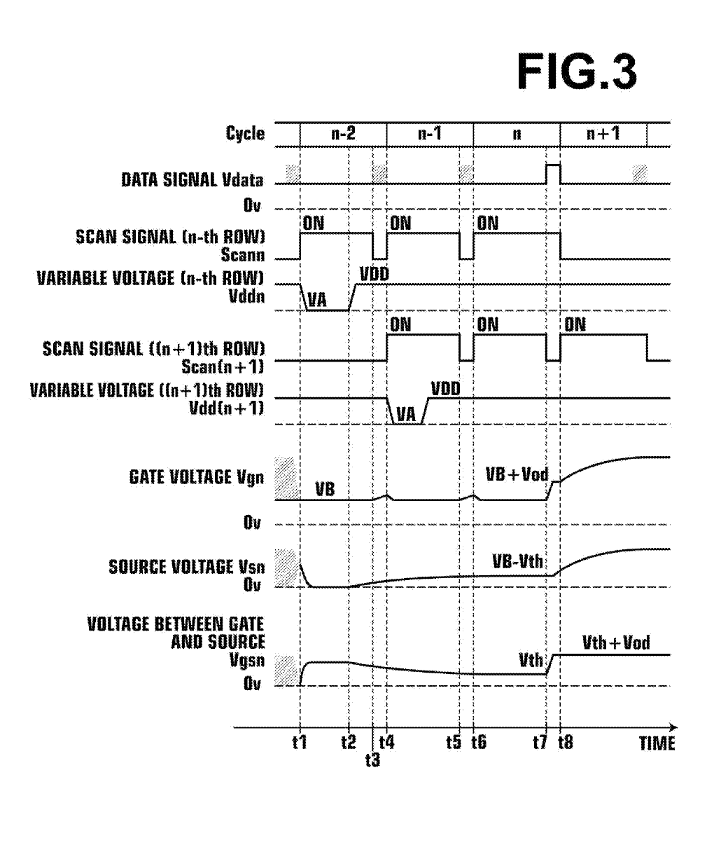

Next, an operation of the organic EL display device according to the present embodiment will be described with reference to the timing chart illustrated in FIG. 3 and FIGS. 4 through 9. In FIG. 3, output timing of scan signal Scann for n-th row and scan signal Scan(n+1) for (n+1)th row, which are output from the scan drive circuit 13, and voltage waveform of variable voltage Vddn for n-th row and variable voltage Vdd(n+1) for (n+1)th row, which are output from the scan drive circuit 13, are illustrated. Further, in FIG. 3, output timing of data signal Vdata output from the data drive circuit 12, and voltage waveforms of gate voltage Vgn, source voltage Vsn and voltage Vgsn between the gate and the source of the drive transistor 11b in the n-th row are illustrated.

In the organic EL display device of the present embodiment, pixel circuits rows connected to the scan lines 14 in the active matrix substrate 10 are sequentially selected, and program operations are performed row by row. Here, an operation performed on the n-th pixel circuit row will be described. FIG. 3 is a timing chart focusing on the operation on the n-th pixel circuit row with respect to the timing of program operations on the (n−2)th pixel circuit row through the (n+1)th pixel circuit row.

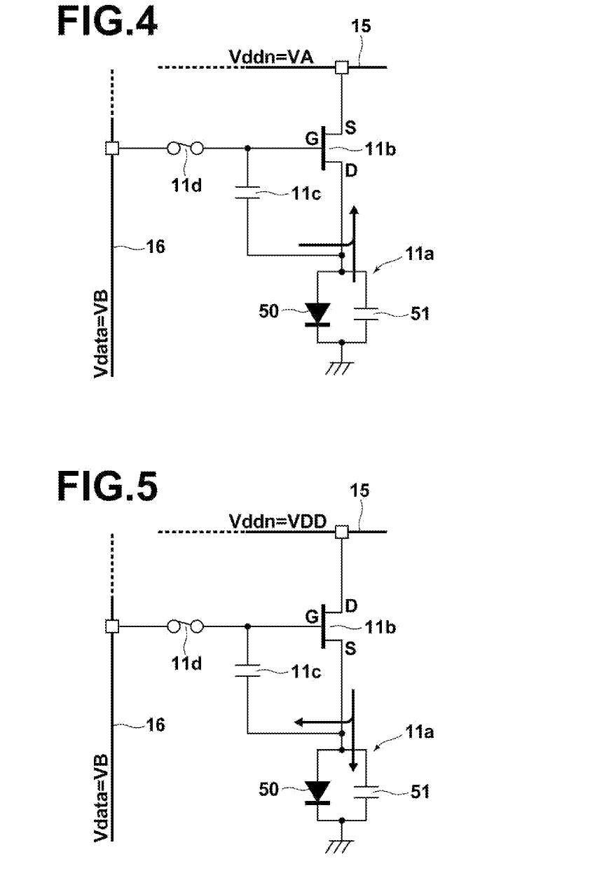

First, a reset operation is performed on the n-th pixel circuit row (please refer to time t1 through time t2 in FIG. 3, and FIG. 4). The reset operation is performed in the time period of selecting the (n−2)th row, which is two lines before the n-th row.

Specifically, as illustrated in FIG. 3, scan signal Scann for turning on the selection transistors 11d is sent from the scan drive circuit 13 to the scan line 14. Further, as illustrated in FIG. 4, the selection transistor 11d is turned on based on the scan signal Scann, and the gate terminal G of the drive transistor 11b is connected to the data line 16. At this time, predetermined voltage VB is supplied from the data drive circuit 12 to each of the data lines, and predetermined voltage VA is supplied from the scan drive circuit 13 to the n-th power source line 15.

The predetermined voltage VB is set higher than the predetermined voltage VA. Therefore, the source terminal S and the drain terminal D of the drive transistor 11b are reversed, and voltage Vgs between the gate and the source of the drive transistor 11b is set (Vgs=VB−VA).

Here, the value of the predetermined voltage VB is set so as to satisfy VB>VA+Vthmax. Vthmax represents the maximum threshold voltage of the drive transistor 11b.

Therefore, some drive current Id flows into the drive transistor 11b, and the drive current Id flows out from the drive transistor 11b to the power source line 15.

Further, the predetermined voltage VA satisfies VA<Vf0−ΔVth when light-emitting threshold voltage of the organic EL light-emitting element 11a is Vf0, and the maximum value of (the threshold voltage deviation of the drive transistor 11b+fluctuation) is ΔVth. For example, the predetermined voltage VA is set as VA=0V. When the value of ΔVth is small, the light-emission transition time period of the organic EL light-emitting element 11a can be reduced by setting higher voltage as the predetermined voltage VA. In contrast, when the value of ΔVth is large, it is necessary to set lower voltage (including negative voltage) as the predetermined voltage VA.

Further, when a certain time period passes, electric discharge from the parasitic capacitance 51 completes, and the anode potential of the organic EL light-emitting element 11a is reset to VA.

Next, a charge operation is performed on the n-th pixel circuit row (please refer to time t2 through time t3, time t4 through time t5, and time t6 through time t7 in FIG. 3, and FIG. 5).

Specifically, voltage output from the scan drive circuit 13 is changed from the predetermined voltage VA to power source voltage

VDD, and the power source line 15 side of the drive transistor 11b becomes drain terminal D, and the organic EL light-emitting element 11a side of the drive transistor 11b becomes source terminal S. Voltage Vgs between the gate and the source of the drive transistor 11b becomes Vgs=Vg−Vs=VB−VA>Vth. Consequently, drive current Id flows from the drive transistor 11b to the organic EL light-emitting element 11a. The parasitic capacitance 51 of the organic EL light-emitting element 11a is charged by the drive current Id, and the source voltage Vs of the drive transistor 11b gradually increases.

This charge operation is performed in the time period of selecting the (n−2)th row, which is two lines before the n-th row, and the (n−1)th row, which is one line before the n-th row. However, during program operation in the time period of selecting the (n−2)th row and the (n−1)th row, program voltage for each row is output to the data line 16 instead of the predetermined voltage VB. Therefore, gate open control is performed on the n-th pixel circuit row during the program operation.

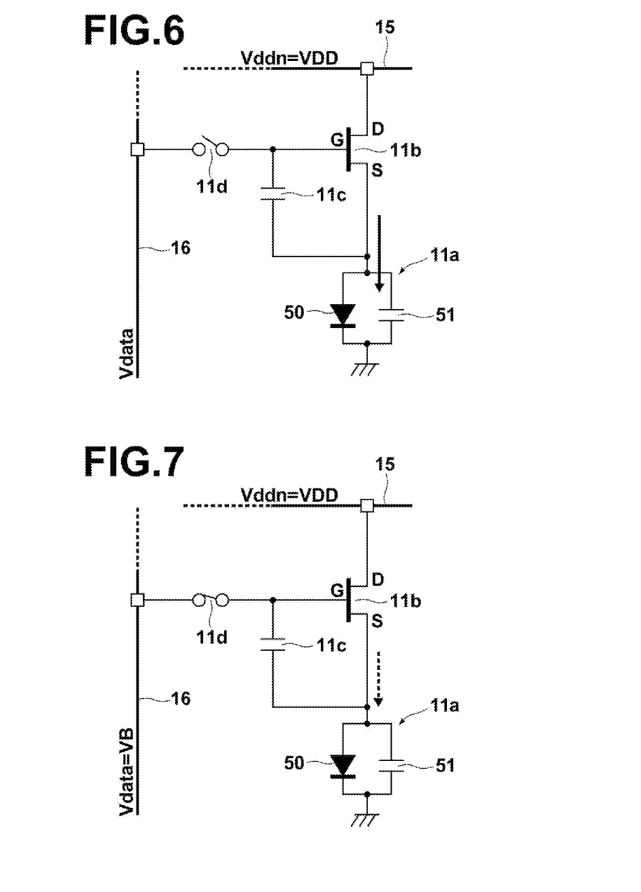

Next, the gate open control will be described (please refer to time t3 through time t4, and time t5 through time t6 in FIG. 3, and FIG. 6).

Specifically, as illustrated in FIG. 3, scan signal Scann for turning off the selection transistor 11d is sent from the scan drive circuit 13 to the scan line 14. Further, as illustrated in FIG. 6, the selection transistor 11d is turned off based on the scan signal Scann, and the gate terminal G of the drive transistor 11b and the data line 16 are temporarily disconnected from each other.

In this state, the parasitic capacitance 51 of the organic EL light-emitting element 11a continues to be charged by the drive current Id. Therefore, the source voltage Vs of the drive transistor 11b increases. Since the gate terminal G of the drive transistor 11b is open, the gate voltage also increases. Therefore, the voltage Vgs between the gate and the source of the drive transistor 11b does not change.

When the time of period of program operation in the time period of selecting the (n−2)th row and the (n−1)th row ends, and predetermined voltage VB is supplied from the data drive circuit 12 to the data line 16 again, the scan signal Scann for turning on the selection transistor 11d is output from the scan drive circuit 13 to the scan line 14 again. Accordingly, the selection transistor 11d is turned on, and the gate terminal G of the drive transistor 11b is connected to the data line 16.

When the gate voltage Vg of the drive transistor 11b returns to the predetermined voltage VB, the voltage Vgs between the gate and the source of the drive transistor 11b drops by the value of an increase in the gate voltage Vg during the aforementioned gate-open time period. In the organic EL display device of the present embodiment, time period of program operation (time t3 through time t4 and time t5 through time t6 in FIG. 3)<<time period of charging the parasitic capacitance (time t2 through time t7 in FIG. 3). Therefore, the drop in the voltage Vgs is substantially the same as the value of a drop in voltage Vgs when the gate voltage Vg is maintained at predetermined voltage VB. Hence, no problem arises.

Next, a threshold voltage detection operation is performed (please refer to time t6 through time t7 in FIG. 3, and FIG. 7).

Specifically, the gate open operation as described above is not performed in the time period of selecting the n-th row, and the parasitic capacitance charge operation as described above is continued to be performed. Since the predetermined voltage VB is supplied to the gate germinal G of the drive transistor 11b, the voltage Vgs between the gate and the source of the drive transistor 11b drops by the increase in the source voltage Vs of the drive transistor 11b. When Vgs=Vth, the drive current Id=0, and the increase of the source voltage Vs stops. At this time, the gate voltage Vg of the drive transistor 11b=VB, and the source voltage Vs of the drive transistor 11b=VB−Vth. Since it is necessary that the source voltage Vs is less than or equal to the light-emitting threshold voltage of the organic EL light-emitting element 11e, the following condition must be satisfied: VB<Vf0+Vthmin. Here, Vf0 represents the light-emitting threshold voltage of the organic EL light-emitting element 11a, and Vthmin represents the minimum threshold voltage of the drive transistor 11b.

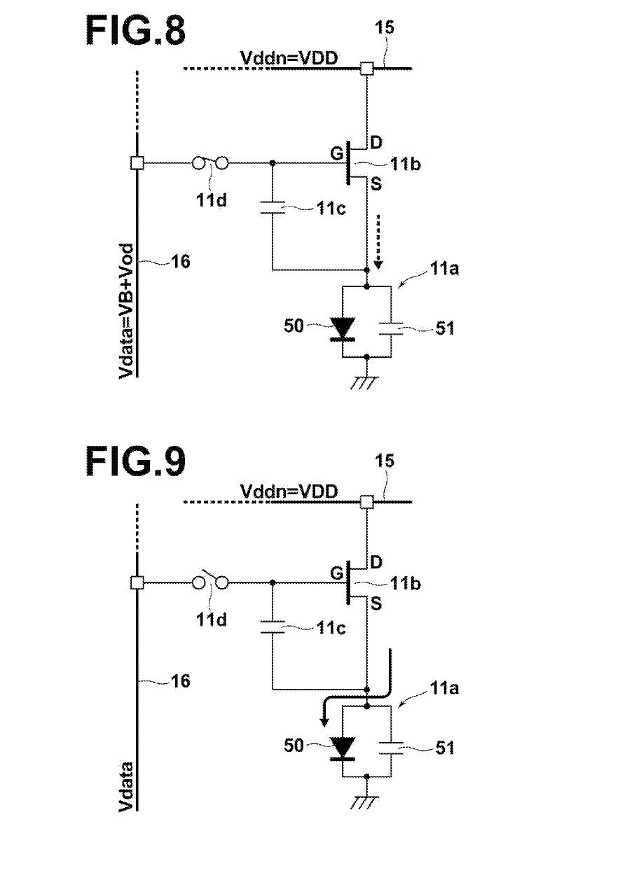

Next, a program operation for the n-th pixel circuit row is performed (please refer to time t7 through time t8 in FIG. 3, and FIG. 8). When the source voltage of the drive transistor 11b is sufficiently stabilized by the threshold voltage detection operation, the data drive circuit 12 steps up the voltage output to each of the data lines 16. The voltage is increased from the predetermined voltage VB to voltage VB+Vod.

Here, voltage Vod is the drive voltage of the drive transistor 11b for supplying drive current corresponding to desirable luminance to the organic EL light-emitting element 11a, and Vod=Vgs−Vth. Meanwhile, the source voltage Vs of the drive transistor 11b is a partial pressure of capacitance value Cs of the capacitance element 11c and capacitance value Cd of the parasitic capacitance 51. Therefore, Vs=VB−Vth+Vod×Cs/(Cd+Cs). However, when Cd>>Cs, Vs≈VB−Vth, and Vgs≈VB+Vod−(VB−Vth)=Vth+Vod. Therefore, the voltage Vgs is substantially the same as a value obtained by adding voltage Vod to voltage Vth detected in the capacitance element 11c.

Next, a light-emitting operation of the n-th pixel circuit row is performed (please refer to time t8 and thereafter in FIG. 3 and FIG. 9).

Specifically, scan signal Scann for turning off the selection transistor 11d is sent from the scan drive circuit 13 to the scan line 14. Consequently, as illustrated in FIG. 9, the selection transistor 11d is turned off based on the scan signal. Accordingly, the gate terminal G of the drive transistor 11b and the data line 16 are disconnected from each other.

Further, as illustrated in FIG. 9, drive current Id corresponding to drive voltage flows into the drive transistor 11b while voltage between both ends of the capacitance element 11c during the aforementioned program operation is maintained. Consequently, the light-emitting unit 50 of the organic EL light-emitting element 11a outputs light by the drive current Id. After application of voltage Vod is completed, it is necessary to turn off the selection transistor 11d before the source voltage Vs of the drive transistor 11b increases.

In the organic EL display device of the present embodiment, the reset operation of a row is started in the time period of selecting a row two lines before the row. Therefore, as illustrated in FIG. 3, a reset operation for the (n+1)th pixel circuit row is started in the period of selecting the (n−1)th pixel circuit row in a manner similar to the aforementioned operation.

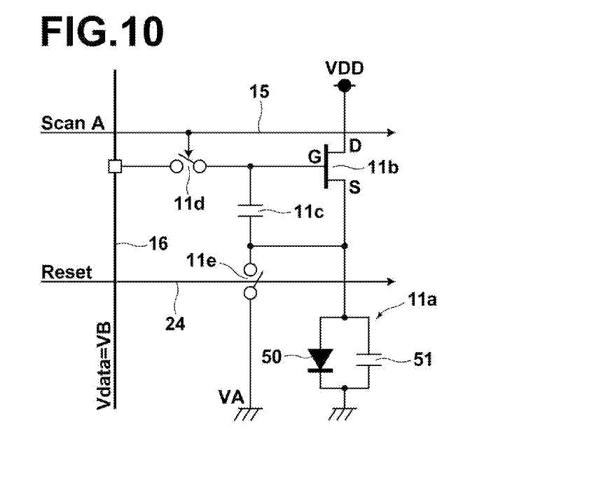

In the above explanation of the operation, the reset operation is performed by changing the voltage supplied to the power source line 15 to predetermined voltage VA. However, it is not necessary that the reset operation is performed in such a manner. For example, as illustrated in FIG. 10, the voltage supplied to the power source line 15 may be fixed at power source voltage VDD, and a reset transistor (a transistor for resetting) 11e and a reset control line 24 may be provided. The reset transistor 11e switches connection between an end of the capacitance element 11c and the predetermined voltage VA (VA=0 in this embodiment) and connection between the source terminal S and the predetermined voltage VA. The reset control line 24 turns on/off the reset transistor 11e. The reset transistor 11e may be turned on during the reset operation to perform a reset operation by supplying the predetermined voltage VA to the source terminal S of the drive transistor 11b.

In the above explanation of the operation, the threshold voltage detection operation including the charge operation of the parasitic capacitance 51 for a row is started two lines before the row. Since the time period necessary to perform such operations is determined by the predetermined voltage VA, VB, the capacitance value Cd of the parasitic capacitance, and the electric current characteristic of the drive transistor 11b, it is necessary to set the time period based on an actual electric current characteristic of the drive transistor 11b and an actual capacitance value Cd of the parasitic capacitance 51.

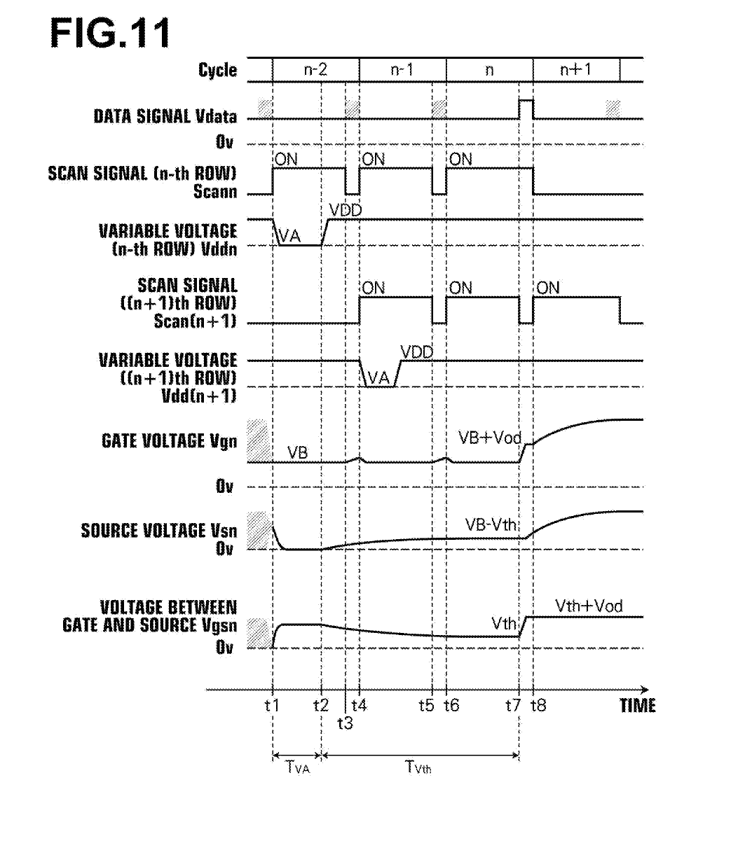

When drive current Id in a sub-threshold region of the drive transistor 11b is large, if the charge time period and the detection time period are increased more than necessary, an error is caused. Therefore, it is necessary to control the time period by a unit time period that is less than or equal to the cycle of the first scan signal ScanAn. Such precise time period control can be performed by adjusting the reset operation time period. Specifically, the threshold voltage detection time period Tᵥₜₕ can be controlled by changing (advancing or delaying) the timing of t2 in the reset time period T_{VA}, illustrated in FIG. 11.

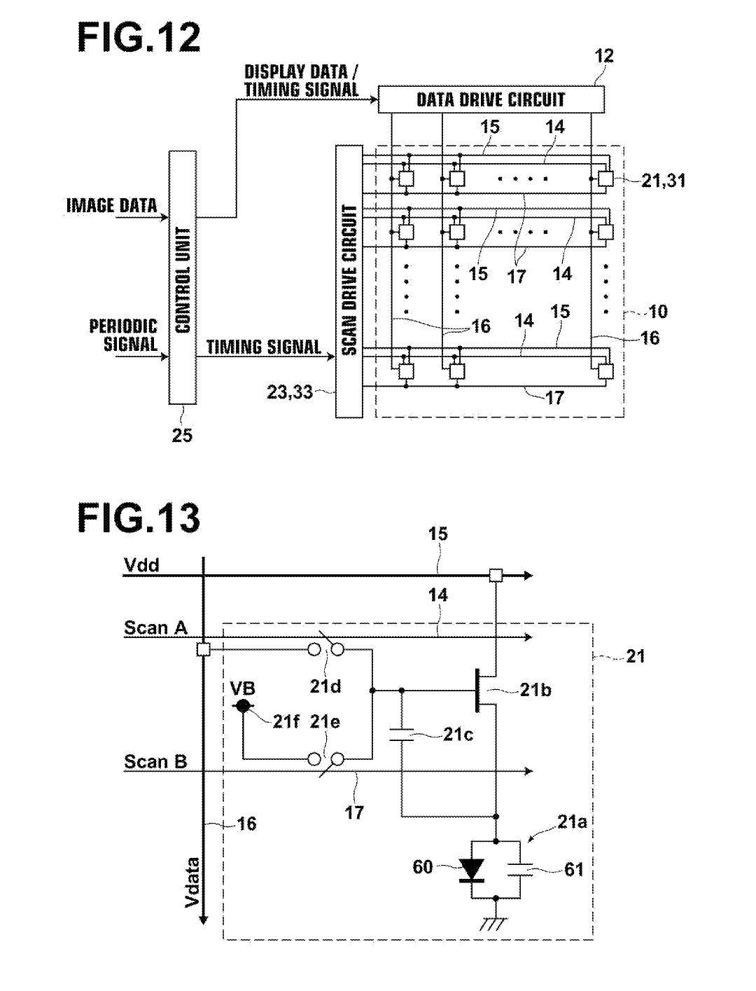

Next, an organic EL display device to which a display device according to a second embodiment of the present invention has been applied will be described. The organic EL display device in the first embodiment is adopted when the off time period of the selection transistor 11d is sufficiently short. In contrast, the organic EL display device of the second embodiment may be adopted even if the off time period of the selection transistor 11d is not sufficiently short. FIG. 12 is a schematic diagram illustrating an organic EL display device to which the second embodiment of the present invention has been applied.

The organic EL display device according to the present embodiment includes an active matrix substrate 10, a data drive circuit 12, a scan drive circuit 23, and a control unit 25 in a manner similar to the organic EL display device of the first embodiment. A multiplicity of pixel circuits 21, each including an organic EL light-emitting element, are two-dimensionally arranged in the active matrix substrate 10. The data drive circuit 12 supplies drive voltage, based on display data, to a gate terminal of a drive transistor in each of the pixel circuits 21. The scan drive circuit 23 outputs a scan signal to each of the pixel circuits 21, and the control unit 25 outputs display data corresponding to image data and a timing signal based on a synchronous signal to the data drive circuit 12.

Further, the active matrix substrate 10 includes a multiplicity of first scan lines 14 (corresponding to the scan lines 14 in the organic EL display device of the first embodiment), a multiplicity of power source lines 15, and a multiplicity of data lines 16 in a manner similar to the organic EL display device of the first embodiment. Further, a multiplicity of second scan lines 17 are provided. The multiplicity of second scan lines 17 send second scan signals ScanB output from the scan drive circuit 23 to each pixel circuit row.

As illustrated in FIG. 13, each of the pixel circuits 21 includes an organic EL light-emitting element 21a, a drive transistor (a transistor for driving the organic EL light-emitting element 21a) 21b, a capacitance element 21c, a first selection transistor (a first transistor for selecting) 21d, and a second selection transistor (a second transistor for selecting) 21e. Source terminal S of the drive transistor 21b is connected to an anode terminal of the organic EL light-emitting element 21a, and the drive transistor 21b supplies drive current to the organic EL light-emitting element 21a. The capacitance element 21c is connected between the gate terminal G and the source terminal S of the drive transistor 21b. One of the ends of the first selection transistor 21d is connected to both of an end of the capacitance element 21c and the gate terminal G of the drive transistor 21b. Further, the other end of the first selection transistor 21d is connected to the data line 16. One of the ends of the second selection transistor 21e is connected to both of an end of the capacitance element 21c and the gate terminal G of the drive transistor 21b. Further, the other end of the second selection transistor 21e is connected to a constant voltage source 21f. Specifically, the pixel circuit 21 of the organic EL display device of the second embodiment differs from the pixel circuit 11 of the first embodiment in that the second selection transistor 21e is provided in the second embodiment. Other elements are similar to the pixel circuit of the first embodiment.

The scan drive circuit 23 in the organic EL display device of the second embodiment sequentially outputs, based on the timing signal output from the control unit 25, first scan signal ScanAn for turning on/off the first selection transistor 21d in each of the pixel circuits 21 to each of the first scan lines 14. Further, the scan drive circuit 23 supplies variable voltage based on operation timing to each of the power source lines 15. Further, the scan drive circuit 23 sequentially outputs second scan signal ScanBn for turning on/off the second selection transistor 21e in each of the pixel circuits 21 to each of the second scan lines 17.

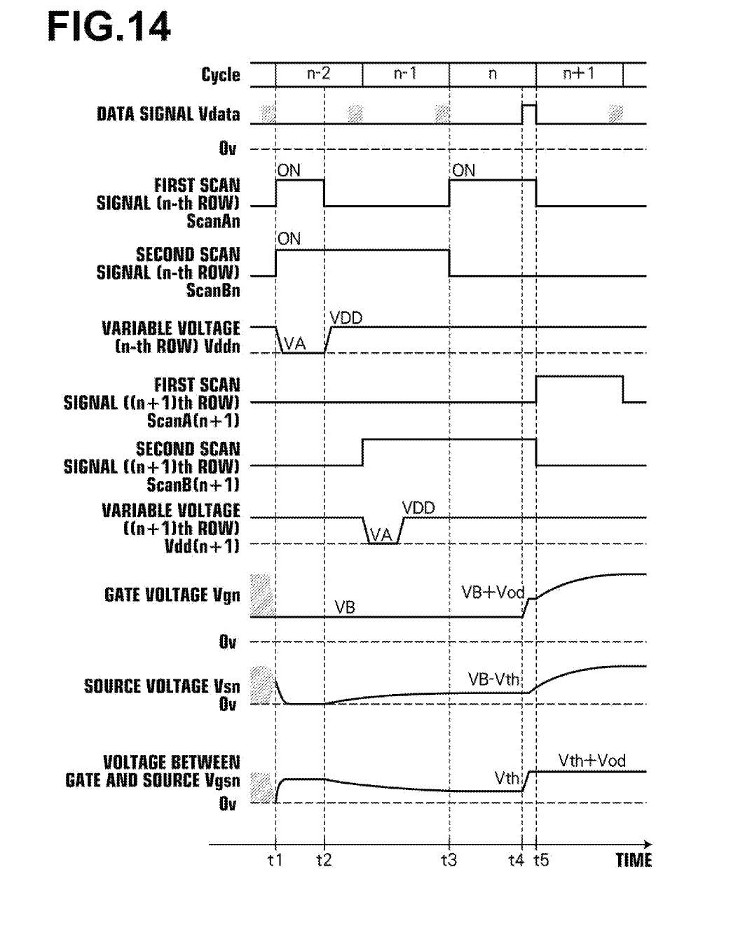

Next, an operation of the organic EL display device according to the present embodiment will be described with reference to the timing chart illustrated in FIG. 14 and FIGS. 15 through 18. In FIG. 14, output timing of first scan signal ScanAn and second scan signal ScanBn for n-th row and first scan signal ScanA(n+1) and second scan signal ScanB (n+1) for (n+1)th row, which are output from the scan drive circuit 23, and voltage waveforms of variable voltage Vddn for n-th row and variable voltage Vdd(n+1) for (n+1)th row, which are output from the scan drive circuit 23, are illustrated. Further, in FIG. 14, output timing of data signal Vdata output from the data drive circuit 12, and voltage waveforms of gate voltage Vgn, source voltage Vsn and voltage Vgsn between the gate and the source of the drive transistor 21b in the n-th row are illustrated.

In the organic EL display device of the present embodiment, pixel circuits rows connected to the first scan lines 14 and the second scan lines 17 in the active matrix substrate 10 are sequentially selected, and program operations are performed row by row. Here, an operation performed on the n-th pixel circuit row will be described. FIG. 14 is a timing chart focusing on the operation on the n-th pixel circuit row with respect to the timing of program operations on the (n−2)th pixel circuit row through the (n+1)th pixel circuit row.

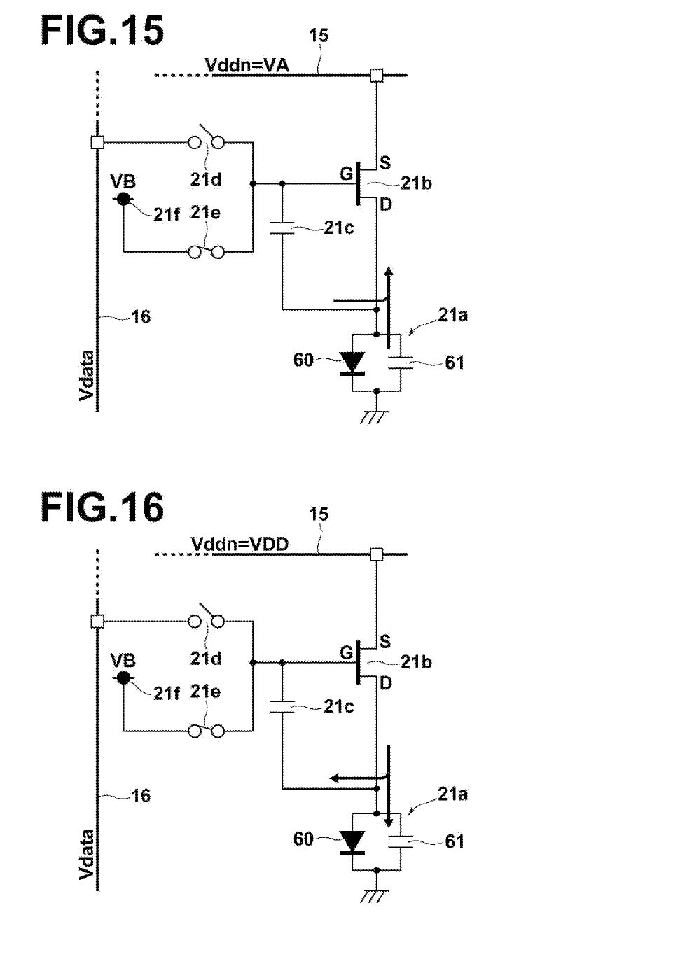

First, a reset operation is performed on the n-th pixel circuit row (please refer to time ti through time t2 in FIG. 14, and FIG. 15) The reset operation on the n-th pixel circuit row is performed in the time period of selecting the (n−2)th row, which is two lines before the n-th row.

Specifically, as illustrated in FIG. 14, the first scan signal ScanAn for turning off the first selection transistor 21d is sent from the scan drive circuit 23 to the first scan line 14, and the second scan signal ScanBn for turning on the second selection transistor 21e is sent from the scan drive circuit 23 to the second scan line 17. Further, as illustrated in FIG. 15, the first selection transistor 21d is turned off based on the first scan signal ScanAn, and the gate terminal G of the drive transistor 21b is disconnected from the data line 16. Meanwhile, the second selection transistor 21e is turned on based on the second scan signal ScanBn, and the gate terminal G of the drive transistor 21b is connected to the constant voltage source 21f.

At this time, predetermined voltage VA is supplied from the scan drive circuit 23 to the n-th power source line 15.

The predetermined voltage VB that is output from the constant voltage source 21f is set higher than the predetermined voltage VA. Therefore, the source terminal S and the drain terminal D of the drive transistor 21b are reversed, and voltage Vgs between the gate and the source of the drive transistor 21b is set (Vgs=VB−VA)

Here, the value of the predetermined voltage VB is set so as to satisfy VB>VA+Vthmax. Therefore, some drive current Id flows into the drive transistor 21b, and the drive current Id flows out from the drive transistor 21b to the power source line 15.

Further, when light-emitting threshold voltage of the organic EL light-emitting element 21a is Vf0, and the maximum value of the threshold voltage deviation of the drive transistor 21b+fluctuation is ΔVth, the predetermined voltage VA satisfies the following condition: VA<Vf0−ΔVth. For example, the predetermined voltage VA is set as VA=0V. When the value of ΔVth is small, the light-emission transition time period of the organic EL light-emitting element 21a can be reduced by setting higher voltage. In contrast, when the value of ΔVth is large, it is necessary to set lower voltage (including negative voltage)

Further, when a certain time period passes, electric discharge from the parasitic capacitance 61 completes, and the anode potential of the organic EL light-emitting element 21a is reset to VA.

Next, a charge operation is performed for the n-th pixel circuit row (please refer to time t2 through time t3 in FIG. 14, and FIG. 16).

Specifically, voltage Vddn output from the scan drive circuit 23 to the power source line 15 is changed from the predetermined voltage VA to power source voltage VDD, and the power source line 15 side of the drive transistor 21b becomes drain terminal D, and the organic EL light-emitting element 21a side of the drive transistor 21b becomes source terminal S, and voltage Vgs between the gate and the source of the drive transistor 21b becomes Vgs=Vg−Vs=VB−VA>Vth. Consequently, drive current Id flows from the drive transistor 21b to the organic EL light-emitting element 21a. The parasitic capacitance 61 of the organic EL light-emitting element 21a is charged by the drive current Id, and the source voltage Vs of the drive transistor 21b gradually increases.

The charge operation is performed in the time period of selecting the (n−2)th row, which is two lines before the n-th row.

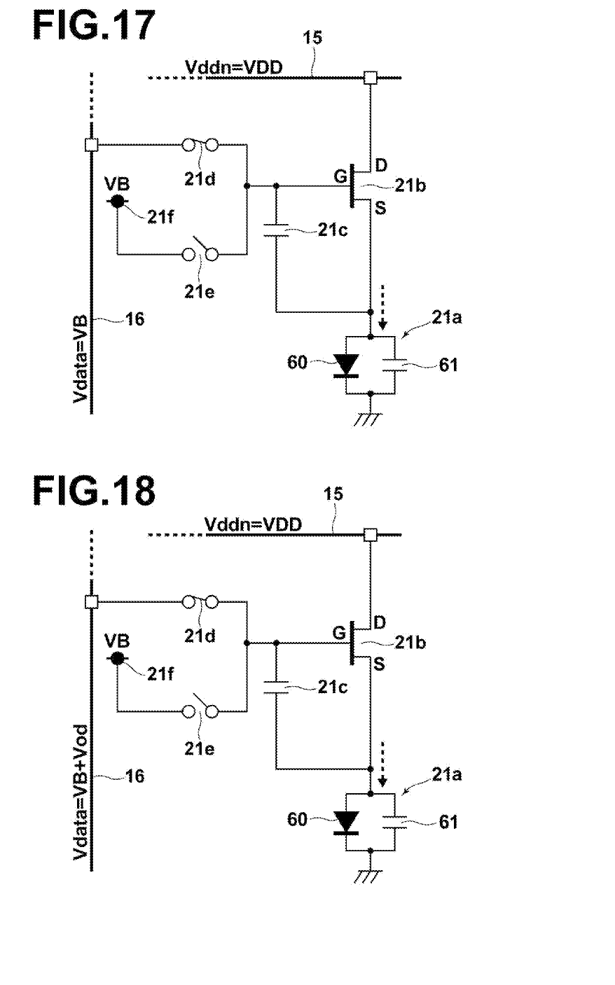

Next, a threshold voltage detection operation is performed (please refer to time t3 through time t4 in FIG. 14, and FIG. 17).

Specifically, as illustrated in FIG. 14, the first scan signal ScanAn for turning on the first selection transistor 21d is output from the scan drive circuit 23 to the first scan line 14, and the second scan signal ScanBn for turning off the second selection transistor 21e is output from the scan drive circuit 23 to the second scan line 17. Further, as illustrated in FIG. 17, the first selection transistor 21d is turned on based on the first scan signal ScanAn, and the gate terminal G of the drive transistor 21 and the data line 16 are connected to each other. The second selection transistor 21e is turned off based on the second scan signal ScanBn, and the gate terminal G of the drive transistor 21b and the constant voltage source 21f are disconnected from each other.

At this time, predetermined voltage VB is output from the data drive circuit 12, and the parasitic capacitance 61 of the organic EL light-emitting element 21a is continued to be charged by the drive current Id following the aforementioned charge operation. Therefore, the source voltage Vs of the drive transistor 21b increases.

Since the predetermined voltage VB is supplied to the gate terminal G of the drive transistor 21b, the voltage Vgs between the gate and the source of the drive transistor 21b decreases by the increase of the source voltage Vs of the drive transistor 21b. When the voltage Vgs reaches Vth (Vgs=Vth), the drive current Id=0, and the increase of the source voltage Vs stops. At this time, the voltage between both ends of the capacitance element 21c is Vcs=Vgs=Vth.

Here, the explanation is based on the premise that no electric current flows to the organic EL light-emitting element 21a. Further, the source voltage Vs of the drive transistor 21b must be less than or equal to the light-emitting threshold voltage of the organic EL light-emitting element 21a. Therefore, the following conditions must be satisfied:

gate voltage Vg of the drive transistor 21b=VB;

source voltage Vs=VB−Vth<Vf0; and

VB<Vf0±Vthmin. The voltage Vf0 is the light-emitting threshold voltage of the organic EL light-emitting element 21a, and voltage Vthmin is the minimum threshold voltage of the drive transistor 21b.

Next, a program operation for the n-th pixel circuit row is performed (please refer to time t4 through time t5 in FIG. 14, and FIG. 18). When the source voltage of the drive transistor 21b is sufficiently stabilized by the threshold voltage detection operation, the data drive circuit 12 steps up the voltage output to each of the data lines 16. The voltage is increased from the predetermined voltage VB to voltage VS+Vod.

Here, voltage Vod is the drive voltage of the drive transistor 21b for supplying drive current corresponding to desirable luminance to the organic EL light-emitting element 21a, and Vod=Vgs−Vth. Meanwhile, the source voltage Vs of the drive transistor 21b is a partial pressure of capacitance value Cs of the capacitance element 21c and capacitance value Cd of the parasitic capacitance 61. Therefore, Vs=VB−Vth±Vod×Cs/(Cd+Cs). However, when Cd>>Cs, Vs≈VB−Vth, and Vgs≈VB+Vod−(VB−Vth)=Vth+Vod. Therefore, the voltage Vgs is substantially the same as a value obtained by adding voltage Vod to voltage Vth detected in the capacitance element 21c.

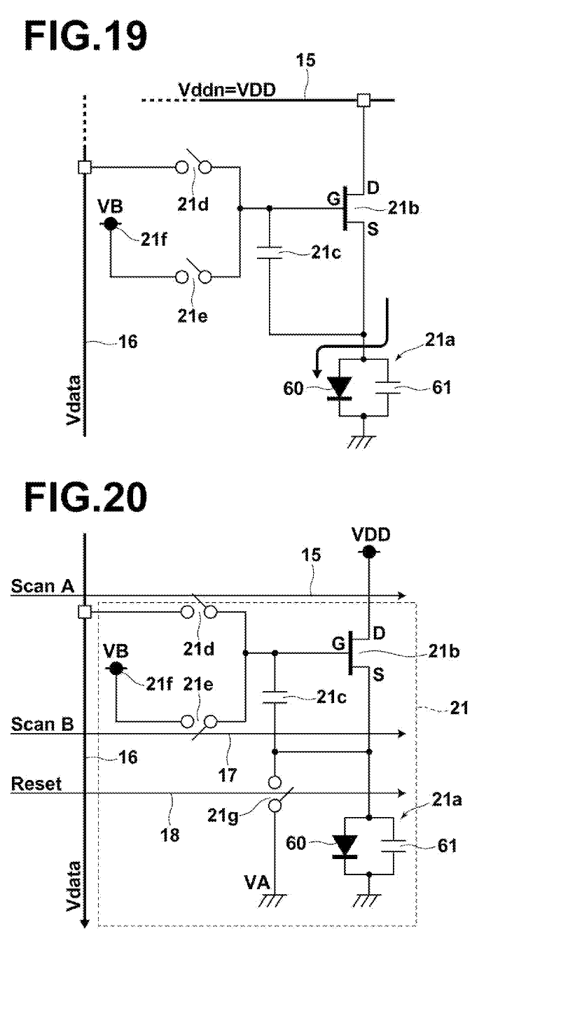

Next, a light-emitting operation of the n-th pixel circuit row is performed (please refer to time t5 and thereafter in FIG. 14, and FIG. 19).

Specifically, the first scan signal ScanAn for turning off the first selection transistor 21d is sent from the scan drive circuit 23 to the first scan line 14. Consequently, as illustrated in FIG. 19, the first selection transistor 21d is turned off based on the first scan signal. Accordingly, the gate terminal G of the drive transistor 21b and the data line 16 are disconnected from each other.

Further, as illustrated in FIG. 19, drive current Id corresponding to drive voltage flows into the drive transistor 21b while voltage between both ends of the capacitance element 21c during the aforementioned program operation is maintained. Consequently, the light-emitting unit 60 of the organic EL light-emitting element 21a outputs light by the drive current Id. After application of voltage Vod is completed, it is necessary to turn off the first selection transistor 21d before the source voltage Vs of the drive transistor 21b increases.

In the organic EL display device of the present embodiment, the reset operation of a row is started in the time period of selecting the row two lines before the row. Therefore, as illustrated in FIG. 14, a reset operation for the (n+1)th pixel circuit row is started in the period of selecting the (n−1)th pixel circuit row in a manner similar to the aforementioned operation.

In the above explanation of the operation, the reset operation is performed by changing the voltage supplied to the power source line 15 to predetermined voltage VA. However, it is not necessary that the reset operation is performed in such a manner. For example, as illustrated in FIG. 20, the voltage supplied to the power source line 15 may be fixed at power source voltage VDD, and a reset transistor (a transistor for resetting) 21g and a reset control line 18 may be provided. The reset transistor 21g switches connection between an end of the capacitance element 21c and the predetermined voltage VA (VA=0 in this embodiment) and connection between the source terminal S and the predetermined voltage VA. The reset control line 18 turns on/off the reset transistor 21g. The reset transistor 21g may be turned on during the reset operation to perform a reset operation by supplying the predetermined voltage VA to the source terminal S of the drive transistor 21b.

In the above explanation of the operation, the threshold voltage detection operation including the charge operation of the parasitic capacitance 61 for a row is started two lines before the row. Since the time period necessary to perform such operations is determined by the predetermined voltage VA, VB, the capacitance value Cd of the parasitic capacitance 61, and the electric current characteristic of the drive transistor 21b, it is necessary to set the time period based on an actual electric current characteristic of the drive transistor 21b and an actual capacitance value Cd of the parasitic capacitance 61. When drive current Id in a sub-threshold region of the drive transistor 21b is large, if the charge time period and the detection time period are increased more than necessary, an error is caused. Therefore, it is necessary to control the time period by a unit time period that is less than or equal to the cycle of the first scan signal ScanAn. Such precise time period control can be performed by adjusting the reset operation time period. The method for controlling is similar to the method described in the first embodiment.

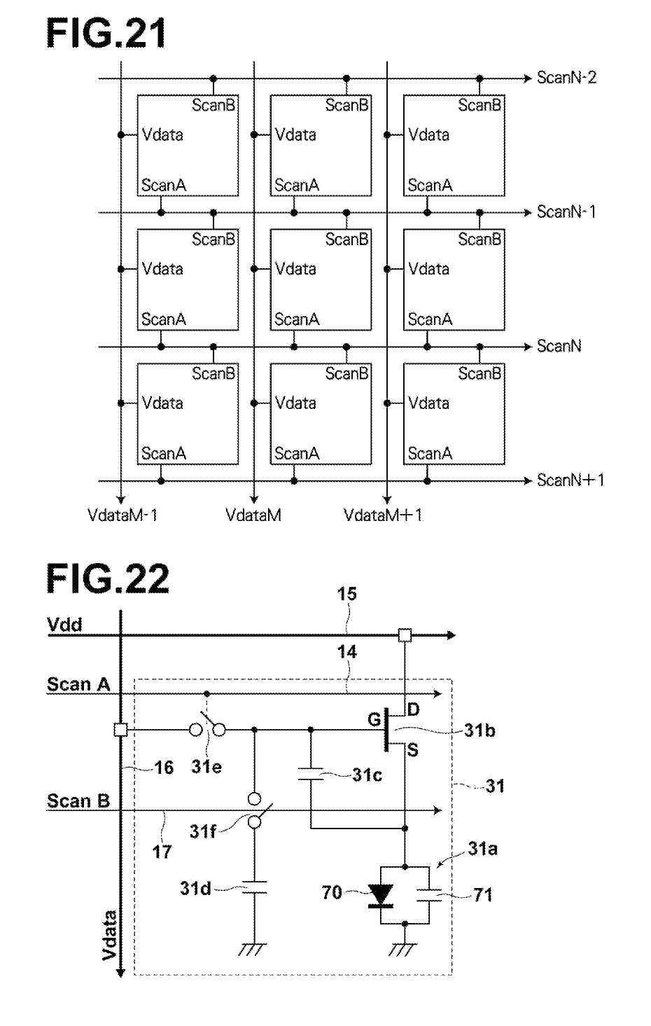

In the above explanation of the operation, the threshold voltage detection operation including the charge operation of the parasitic capacitance 61 is started two lines before the n-th row. However, for example, when it is sufficient to start the threshold voltage detection operation one line before the n-th row (in other words, the threshold voltage can be detected by starting the operation one line before the n-th row), the first scan signal ScanA(n−1) for the (n−1)th row, which is one line before the n-th row, may be used as the second scan signal ScanBn. Specifically, as illustrated in FIG. 21, for example, a common scan line may be used as the first scan line that supplies the first scan signal ScanA(n−1) to the (n−1)th pixel circuit row and the second scan line that supplies the second scan signal ScanBn to the n-th pixel circuit row. Therefore, it is possible to reduce the number of the scan lines to half.

Next, an organic EL display device to which a display device according to a third embodiment of the present invention has been applied will be described. The schematic configuration of the whole organic EL display device according to the third embodiment of the present invention is similar to that of the organic EL display device according to the second embodiment of the present invention, illustrated in FIG. 11. However, the structure of the pixel circuit and the method for driving the pixel circuit of the third embodiment differ from those of the second embodiment.

The organic EL display device according to the present embodiment includes an active matrix substrate 10, a data drive circuit 12, a scan drive circuit 33, and a control unit 25 in a manner similar to the organic EL display device of the second embodiment. A multiplicity of pixel circuits 31, each including an organic EL light-emitting element, are two-dimensionally arranged in the active matrix substrate 10. The data drive circuit 12 supplies drive voltage, based on display data, to a gate terminal of a drive transistor in each of the pixel circuits 31. The scan drive circuit 33 outputs a scan signal to each of the pixel circuits 31, and the control unit 25 outputs display data corresponding to image data and a timing signal based on a synchronous signal to the data drive circuit 12.

Further, the active matrix substrate 10 includes a multiplicity of first scan lines 14, a multiplicity of second scan lines 17, a multiplicity of power source lines 15, and a multiplicity of data lines 16 in a manner similar to the organic EL display device of the second embodiment.

As illustrated in FIG. 22, each of the pixel circuits 31 includes an organic EL light-emitting element 31a, a drive transistor (a transistor for driving the organic EL light-emitting element 31a) 31b, a capacitance element 31c, a first selection transistor (a first transistor for selecting) 31e, a second selection transistor (a second transistor for selecting) 31f, and a capacitance element 31d for storing gate bias voltage. Source terminal S of the drive transistor 31b is connected to an anode terminal of the organic EL light-emitting element 31a, and the drive transistor 31b supplies drive current to the organic EL light-emitting element 31a. The capacitance element 31c is connected between the gate terminal G and the source terminal S of the drive transistor 31b. One of the ends of the first selection transistor 31e is connected to both of an end of the capacitance element 31c and the gate terminal G of the drive transistor 31b. Further, the other end of the first selection transistor 31e is connected to the data line 16. One of the ends of the second selection transistor 31f is connected to both of an end of the capacitance element 31c and the gate terminal G of the drive transistor 31b. Further, the other end of the second selection transistor 31f is connected to the capacitance element 31d for storing gate bias voltage. The capacitance element 31d for storing the gate bias voltage is connected to the other end of the second selection transistor 31f. Specifically, the pixel circuit 31 of the organic EL display device of the third embodiment differs from the pixel circuit 21 of the second embodiment in that the capacitance element 31d for storing the gate bias voltage and the second selection transistor 31f connected to the capacitance element 31d for storing the gate bias voltage are provided in the third embodiment. Other elements are similar to the pixel circuit of the second embodiment.

The scan drive circuit 33 in the organic EL display device of the third embodiment sequentially outputs, based on the timing signal output from the control unit 25, first scan signal ScanAn for turning on/off the first selection transistor 31e in each of the pixel circuits 31 to each of the first scan lines 14. Further, the scan drive circuit 33 supplies variable voltage based on operation timing to each of the power source lines 15. Further, the scan drive circuit 33 sequentially outputs second scan signal ScanBn for turning on/off the second selection transistor 31f in each of the pixel circuits 31 to each of the second scan lines 17.

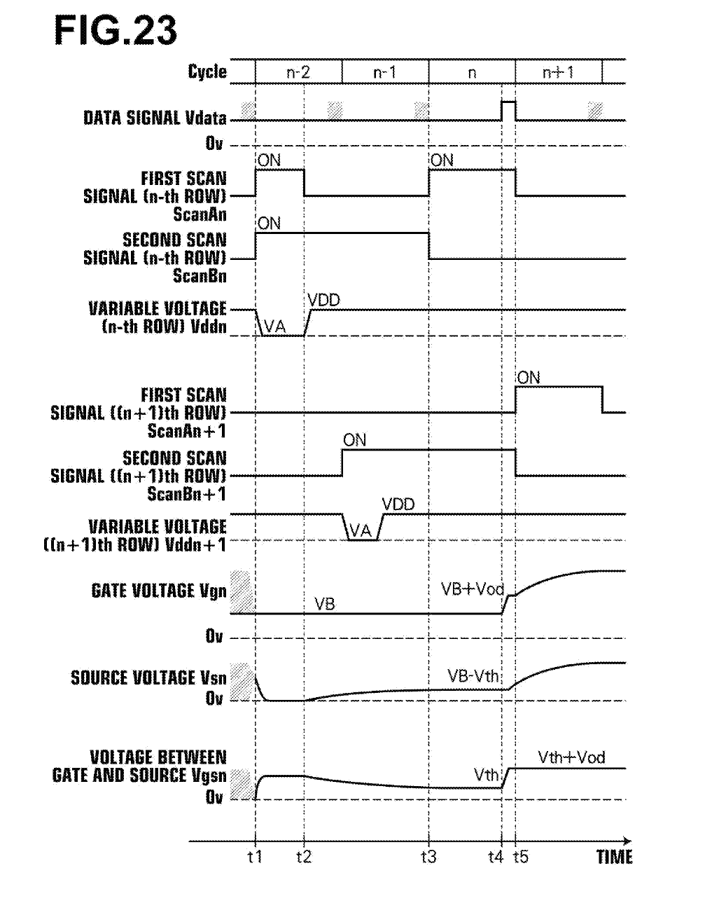

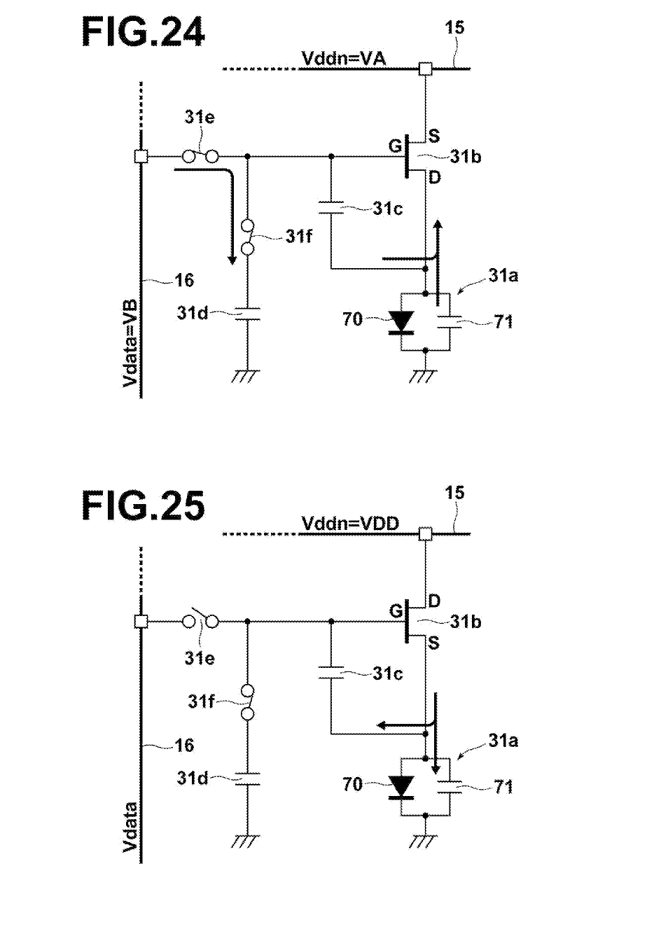

Next, an operation of the organic EL display device according to the present embodiment will be described with reference to the timing chart illustrated in FIG. 23, and FIGS. 24 through 27. In FIG. 23, output timing of first scan signal ScanAn and second scan signal ScanBn for the n-th row and first scan signal ScanA(n+1) and second scan signal ScanB(n+1) for the (n+1)th row, which are output from the scan drive circuit 33, and voltage waveform of variable voltage Vddn for n-th row and variable voltage Vdd(n+1) for (n+1)th row, which are output from the scan drive circuit 33, are illustrated. Further, in FIG. 23, output timing of data signal Vdata output from the data drive circuit 12, and voltage waveforms of gate voltage Vgn, source voltage Vsn and voltage Vgsn between the gate and the source of the drive transistor 31b in the n-th row are illustrated.

In the organic EL display device of the present embodiment, pixel circuits rows connected to the first scan lines 14 and the second scan lines 17 in the active matrix substrate 10 are sequentially selected, and program operations are performed row by row. Here, an operation performed on the n-th pixel circuit row will be described. FIG. 23 is a timing chart focusing on the operation on the n-th pixel circuit row with respect to the timing of program operations on the (n−2)th pixel circuit row through the (n+1)th pixel circuit row.

First, a reset operation is performed on the n-th pixel circuit row (please refer to time t1 through time t2 in FIG. 23, and FIG. 24). The reset operation is performed in the time period of selecting the (n−2)th row, which is two lines before the n-th row.

Specifically, as illustrated in FIG. 23, the first scan signal ScanAn for turning on the first selection transistor 31e is sent from the scan drive circuit 33 to the first scan line 14, and the second scan signal ScanBn for turning on the second selection transistor 31f is sent from the scan drive circuit 33 to the second scan line 17. Further, as illustrated in FIG. 24, the first selection transistor 31e is turned on based on the first scan signal ScanAn, and the gate terminal G of the drive transistor 31b is connected to the data line 16. Meanwhile, the second selection transistor 31f is turned on based on the second scan signal ScanBn, and the capacitance element 31d for storing the gate bias voltage is connected to the data line 16.

Further, the scan drive circuit 33 supplies predetermined voltage VA to the power source line 15 in the n-th row. Further, the data drive circuit 12 supplies predetermined voltage VB to each of the data lines 16. Accordingly, a reset operation is performed in a similar manner to the second embodiment, and the anode potential of the organic EL light-emitting element 31a is reset to VA.

The capacitance element 31d for storing the gate bias voltage is charged by supply of the predetermined voltage VB to the data line 16, and the voltage between both ends of the capacitance element 31d for storing the gate bias voltage becomes voltage VB.

Next, a charge operation is performed on the pixel circuit row in the n-th row (please refer to time t2 through time t3 in FIG. 23, and FIG. 25)

Specifically, voltage Vddn output from the scan drive circuit 33 to the power source line 15 is changed from the predetermined voltage VA to power source voltage VDD, and the power source line 15 side of the drive transistor 31b becomes drain terminal D, and the organic EL light-emitting element 31a side of the drive transistor 31b becomes source terminal S. Further, the scan drive circuit 33 sends the first scan signal ScanAn for turning off the first selection transistor 31e to the first scan line 14, and the first transistor 31e is turned off based on the first scan signal ScanAn. The predetermined voltage VB stored in the capacitance element 31d for storing the gate bias voltage is supplied to the gate terminal G of the drive transistor 31b.

Accordingly, the voltage Vgs between the gate and the source of the drive transistor 31b becomes Vgs=Vg−Vs=VB−VA>Vth. Consequently, drive current Id flows from the drive transistor 31b to the organic EL light-emitting element 31a. The parasitic capacitance 71 of the organic EL light-emitting element 31a is charged by the drive current Id, and the source voltage Vs of the drive transistor 31b gradually increases.

The charge operation for the n-th row is performed in the time period of selecting the (n−2)th row, which is two lines before the n-th row.

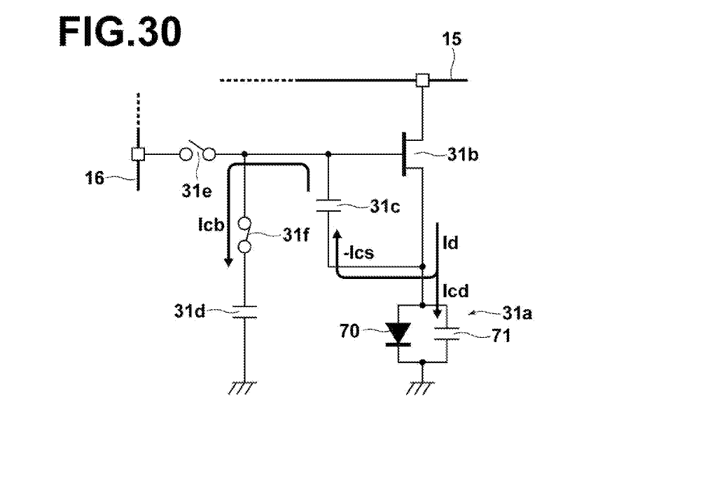

To be accurate, in the charge operation, the drive current Id branches to the parasitic capacitance 71 and the capacitance element 31c, as illustrated in FIG. 30. When the capacitance value of the parasitic capacitance 71 is Cd, and the capacitance value Cs of the capacitance element 31c is Cs, the ratio between Cd and Cs is as follows:

Icd:Ics=Cd:Cs.

Further, electric current Icb that is substantially similar to Ics flows to the capacitance element 31d for storing gate bias voltage. When the capacitance value of the capacitance element 31d for storing the gate bias voltage is Cb, and the variation of a charge amount is ΔQb, increase ΔVg of the gate voltage Vg in time Δt is as follows:

ΔVg=ΔQb/Cb=IcbΔt/Cb=IcsΔt/Cb=(Cs/Cd)IcdΔt=ΔVsCs/Cb.

Therefore, it is necessary that ΔVg is sufficiently smaller than ΔVs to maintain the gate voltage Vg at VB during charge, and Cb must satisfy the following condition:

Cb>>Cs.

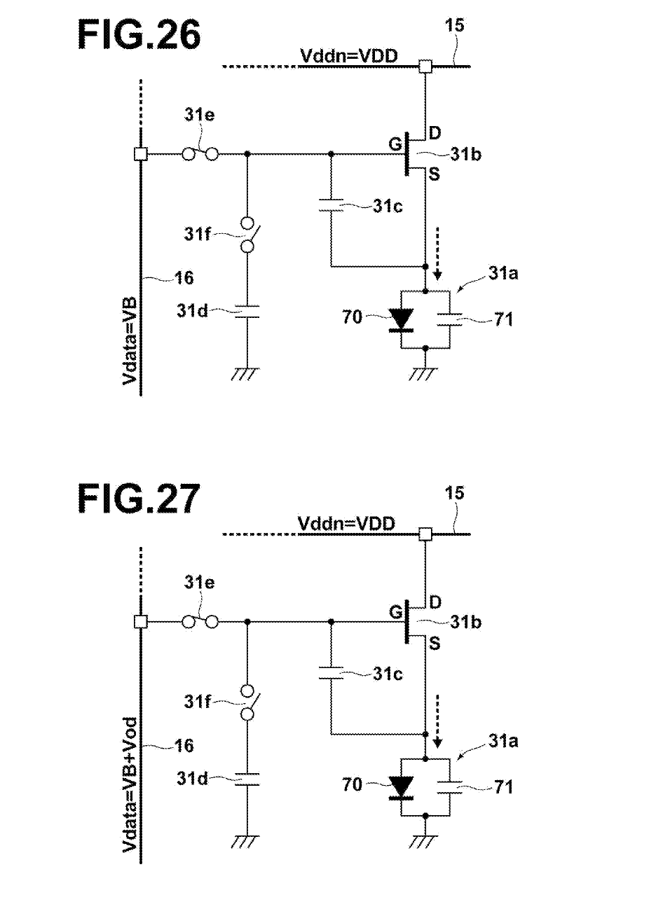

Next, a threshold voltage detection operation is performed (please refer to time t3 through time t4 in FIG. 23, and FIG. 26).

Specifically, as illustrated in FIG. 23, the first scan signal ScanAn for turning on the first selection transistor 31e is output from the scan drive circuit 33 to the first scan line 14, and the second scan signal ScanBn for turning off the second selection transistor 31f is output from the scan drive circuit 33 to the second scan line 17. Further, as illustrated in FIG. 26, the first selection transistor 31e is turned on based on the first scan signal ScanAn, and the gate terminal G of the drive transistor 31b and the data line 16 are connected to each other. The second selection transistor 31f is turned off based on the second scan signal ScanBn, and the gate terminal G of the drive transistor 31b and the capacitance element 31d for storing gate bias voltage are disconnected from each other.

At this time, predetermined voltage VB is output from the data drive circuit 12, and the parasitic capacitance 71 of the organic EL light-emitting element 31a is continued to be charged by the drive current Id following the aforementioned charge operation. Therefore, the source voltage Vs of the drive transistor 31b increases.

Since the predetermined voltage VB is supplied to the gate terminal G of the drive transistor 31b, the voltage Vgs between the gate and the source of the drive transistor 31b decreases by the increase of the source voltage Vs of the drive transistor 31b. When the voltage Vgs reaches Vth (Vgs=Vth), the drive current Id=0, and the increase of the source voltage Vs stops. At this time, the voltage Vcs between both ends of the capacitance element 31c=Vgs=Vth.

Here, the explanation is based on the premise that no electric current flows to the organic EL light-emitting element 31a. Further, the source voltage Vs of the drive transistor 31b must be less than or equal to the light-emitting threshold voltage of the organic EL light-emitting element 31a. Therefore, the following conditions must be satisfied:

gate voltage Vg of the drive transistor 31b=VB;

source voltage Vs=VB−Vth<Vf0; and

VB<Vf0+Vthmin. The voltage Vf0 is the light-emitting threshold voltage of the organic EL light-emitting element 31a, and voltage Vthmin is the minimum threshold voltage of the drive transistor 31b.

Next, a program operation for the n-th pixel circuit row is performed (please refer to time t4 through time t5 in FIG. 23, and FIG. 27). When the source voltage of the drive transistor 31b is sufficiently stabilized by the threshold voltage detection operation, the data drive circuit 12 steps up the voltage output to each of the data lines 16. The voltage is increased from the predetermined voltage VB to voltage VB+Vod.

Here, voltage Vod is the drive voltage of the drive transistor 31b for supplying drive current corresponding to desirable luminance to the organic EL light-emitting element 31a, and Vod=Vgs−Vth. Meanwhile, the source voltage Vs of the drive transistor 31b is a partial pressure of capacitance value Cs of the capacitance element 31c and capacitance value Cd of the parasitic capacitance 71. Therefore, Vs=VB−Vth+Vod×Cs/(Cd+Cs). However, when Cd>>Cs, Vs≈VB−Vth, and Vgs≈VB+Vod−(VB−Vth)=Vth+Vod. Therefore, the voltage Vgs is substantially the same as a value obtained by adding voltage Vod to voltage Vth detected in the capacitance element 31c.

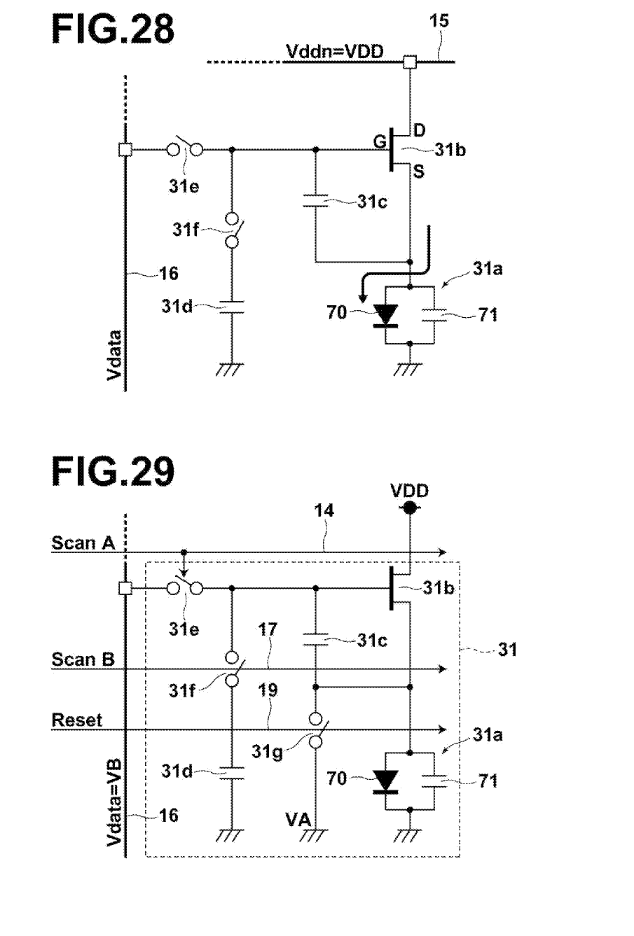

Next, a light-emitting operation of the n-th pixel circuit row is performed (please refer to time t5 and thereafter in FIG. 23, and FIG. 28).

Specifically, the first scan signal ScanAn for turning off the first selection transistor 31e is sent from the scan drive circuit 33 to the first scan line 14. Consequently, as illustrated in FIG. 23, the first selection transistor 31e is turned off based on the first scan signal. Accordingly, the gate terminal G of the drive transistor 31b and the data line 16 are disconnected from each other.

Further, as illustrated in FIG. 28, drive current Id corresponding to drive voltage flows into the drive transistor 31b while voltage between both ends of the capacitance element 31c during the program operation is maintained. Consequently, the light-emitting unit 70 of the organic EL light-emitting element 31a outputs light by the drive current Id. After application of voltage Vod is completed, it is necessary to turn off the first selection transistor 31e before the source voltage Vs of the drive transistor 31b increases.

In the organic EL display device of the present embodiment, the reset operation of a row is started in the time period of selecting the row two lines before the row. Therefore, as illustrated in FIG. 23, a reset operation on the (n+1)th pixel circuit row is started in the period of selecting the (n−1)th pixel circuit row in a manner similar to the aforementioned operation.

In the above explanation of the operation, the reset operation is performed by changing the voltage supplied to the power source line 15 to predetermined voltage VA. However, it is not necessary that the reset operation is performed in such a manner. For example, as illustrated in FIG. 29, the voltage supplied to the power source line 15 may be fixed at power source voltage VDD, and a reset transistor (a transistor for resetting) 31g and a reset control line 19 may be provided. The reset transistor 31g switches connection between an end of the capacitance element 31c and the predetermined voltage VA (VA=0 in this embodiment) and connection between the source terminal S and the predetermined voltage VA. The reset control line 19 turns on/off the reset transistor 31g. The reset transistor 31g may be turned on during the reset operation to perform a reset operation by supplying the predetermined voltage VA to the source terminal S of the drive transistor 31b.

In the above description, the time period of charging the capacitance element 31d for storing gate bias voltage and the reset time period are a common period (within the same period). However, it is not necessary that the time period of charging the capacitance element 31d for storing gate bias voltage and the time period of resetting are accurately synchronized with each other. The charge time period may be before or after the time period of resetting.

In the above explanation of the operation, the threshold voltage detection operation including the charge operation of the parasitic capacitance 71 for a row is started two lines before the row. Since the time period necessary to perform such operations is determined by the predetermined voltage VA, VB, the capacitance value Cd of the parasitic capacitance, and the electric current characteristic of the drive transistor 31b, it is necessary to set the time period based on an actual electric current characteristic of the drive transistor 31b and an actual capacitance value Cd of the parasitic capacitance 71. When drive current Id in a sub-threshold region of the drive transistor 31b is large, if the charge time period and the detection time period are increased more than necessary, an error is caused. Therefore, it is necessary to control the time period by a unit time period that is less than or equal to the cycle of the first scan signal ScanAn. Such precise time period control can be performed by adjusting the reset operation time period. The method for controlling is similar to the method described in the first embodiment.

In the above explanation of the operation, the threshold voltage detection operation including the charge operation of the parasitic capacitance 71 is started two lines before the row. However, for example, when it is sufficient to start the threshold voltage detection operation one line before the n-th row (in other words, the threshold voltage can be detected by starting the operation one line before the n-th row), the first scan signal ScanA(n−1) for the (n−1)th row, which is one line before the n-th row, may be used as the second scan signal ScanBn. Specifically, in the third embodiment, as illustrated in FIG. 21, for example, a common scan line may be used as the first scan line that supplies the first scan signal ScanA(n−1) to the (n−1)th pixel circuit row and the second scan line that supplies the second scan signal ScanBn to the n-th pixel circuit row in a manner similar to the second embodiment. Therefore, it is possible to reduce the number of the scan lines to half.

In the organic EL display devices according to the aforementioned embodiments, each voltage operation is structured by an analog circuit or a digital circuit. However, such circuit structures are used only as an example for explaining the content of the operation, and the structure is not limited to the aforementioned example.

In the embodiments of the present invention, the display device of the present invention is applied to the organic EL display device. However, the light-emitting element is not limited to the organic EL light-emitting element. For example, an inorganic EL element or the like may be used as the light-emitting element.

Further, the display device according to the present invention may be used for various purposes, such as mobile information terminals (a pocket electronic organizer, a mobile computer, a cellular phone and the like), video cameras, digital cameras, personal computers and TV's, for example.

1-12. (canceled)

13. A drive control method of a display device that includes:
an active matrix substrate in which a multiplicity of pixel circuits are arranged, each of the multiplicity of pixel circuits having a light-emitting element, an N-type drive transistor for driving the light-emitting element by supplying drive current to the light-emitting element, and a source terminal of the N-type drive transistor being connected to an anode terminal of the light-emitting element, a capacitance element connected between a gate terminal and the source terminal of the N-type drive transistor, and a selection transistor for switching connection between the gate terminal of the N-type drive transistor and a data line through which a drive voltage to be supplied to the N-type drive transistor is set; and
a scan drive circuit that selects a pixel circuit row in which the pixel circuits are arranged in a direction perpendicular to the direction of the data line by sequentially switching pixel circuit rows and connects each of the pixel circuits in the selected pixel circuit row and the data line by turning on the selection transistors in the selected pixel circuit row, the method comprising the steps of:
setting a predetermined voltage to the gate terminal of the drive transistor in each of the pixel circuits in a predetermined pixel circuit row in a time period of selecting a pixel circuit row that is different from the predetermined pixel circuit row before a time period of selecting the predetermined pixel circuit row;
charging a parasitic capacitance of the light-emitting element in each of the pixel circuits in the predetermined pixel circuit row based on the set predetermined voltage, and starting detection of a threshold voltage of the drive transistor in each of the pixel circuits;
completing detection of the threshold voltage within the time period of selecting the predetermined pixel circuit row; and
setting the drive voltage to the drive transistor in each of the pixel circuits in the predetermined pixel circuit row.

14. A drive control method of a display device, as defined in claim 13, wherein the gate terminal of the drive transistor in each of the pixel circuits in the predetermined pixel circuit row is connected to the data line by turning on the selection transistor in each of the pixel circuits in the predetermined pixel circuit row while the predetermined voltage is set to the data line in a time period from the start to the completion of detecting the threshold voltage in each of the pixel circuits in the predetermined pixel circuit row, and wherein the gate terminal of the drive transistor in each of the pixel circuits in the predetermined pixel circuit row is disconnected from the data line by turning off the selection transistor in each of the pixel circuits in the predetermined pixel circuit row while a drive voltage of a drive transistor in each of pixel circuits in the pixel circuit row that is different from the predetermined pixel circuit row is set to the data line in the time period from the start to the completion of detecting a threshold voltage in each of the pixel circuits in the predetermined pixel circuit row.

15. A drive control method of a display device, as defined in claim 13, wherein a constant voltage supply transistor for switching connection between the gate terminal of the drive transistor and a constant voltage source is provided parallel to the selection transistor with respect to the gate terminal of the drive transistor in each of the pixel circuits, and wherein the selection transistor is turned off and the constant voltage supply transistor is turned on to set a constant voltage from the constant voltage source to the drive transistor in each of the pixel circuits in the predetermined pixel circuit row while the threshold voltage in the predetermined pixel circuit row is detected, and wherein the constant voltage supply transistor is turned off and the selection transistor is turned on while the drive voltage is set to the drive transistor in each of the pixel circuits in the predetermined pixel circuit row.

16. A drive control method of a display device, as defined in claim 13, wherein a constant voltage supply transistor is provided parallel to the selection transistor with respect to the gate terminal of the drive transistor in each of the pixel circuits, and wherein a gate voltage storage capacitance element for supplying, through the constant voltage supply transistor, a constant voltage to the gate terminal of the drive transistor in each of the pixel circuits is provided, and wherein the data line and the gate voltage storage capacitance element are connected to the gate terminal of the drive transistor in each of the pixel circuits in the predetermined pixel circuit row by turning on the selection transistor and the constant voltage supply transistor, and after then, the threshold voltage in the predetermined pixel circuit row is detected by turning off the selection transistor to disconnect the gate terminal of the drive transistor in each of the pixel circuits in the predetermined pixel circuit row from the data line and by keeping the constant voltage supply transistor in an ON state, and wherein the constant voltage supply transistor is turned off and the selection transistor is turned on while the drive voltage is set to the drive transistor in each of the pixel circuits in the predetermined pixel circuit row.

17. A drive control method of a display device, as defined in claim 15, a common scan line is used as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

18. A drive control method of a display device, as defined in claim 16, a common scan line is used as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

19. A drive control method of a display device, as defined in claim 13, wherein the time period of detecting the threshold voltage in each of the pixel circuits in the predetermined pixel circuit row is controlled by adjusting a time period of a reset operation performed on each of the pixel circuits before detecting the threshold voltage.

20. A display device comprising:
an active matrix substrate in which a multiplicity of pixel circuits are arranged, each of the multiplicity of pixel circuits including a light-emitting element, an N-type drive transistor for driving the light-emitting element by supplying drive current to the light-emitting element, and a source terminal of the N-type drive transistor being connected to an anode terminal of the light-emitting element, a capacitance element connected between a gate terminal and the source terminal of the N-type drive transistor, and a selection transistor for switching connection between the gate terminal of the N-type drive transistor and a data line through which a drive voltage to be supplied to the N-type drive transistor is set;
a scan drive circuit that selects a pixel circuit row in which the pixel circuits are arranged in a direction perpendicular to the direction of the data line by sequentially switching pixel circuit rows and connects each of the pixel circuits in the selected pixel circuit row and the data line by turning on the selection transistors in the selected pixel circuit row;
a voltage setting unit that sets a predetermined voltage to the gate terminal of the drive transistor in each of the pixel circuits in a predetermined pixel circuit row in a time period of selecting a pixel circuit row that is different from the predetermined pixel circuit row before a time period of selecting the predetermined pixel circuit row;
a threshold voltage detection unit that charges a parasitic capacitance of the light-emitting element in each of the pixel circuits in the predetermined pixel circuit row based on the predetermined voltage that has been set by the voltage setting unit, and starts detection of a threshold voltage of the drive transistor in each of the pixel circuits, and completes detection of the threshold voltage within the time period of selecting the predetermined pixel circuit row; and
a drive voltage setting unit that sets the drive voltage to the drive transistor in each of the pixel circuits in the predetermined pixel circuit row after the threshold voltage detection unit has completed detection of the threshold voltage.

21. A display device, as defined in claim 20, wherein the threshold voltage detection unit connects the gate terminal of the drive transistor in each of the pixel circuits in the predetermined pixel circuit row to the data line by turning on the selection transistor in each of the pixel circuits in the predetermined pixel circuit row while the predetermined voltage is set to the data line in a time period from the start to the completion of detecting the threshold voltage in each of the pixel circuits in the predetermined pixel circuit row, and wherein the threshold voltage detection unit disconnects the gate terminal of the drive transistor in each of the pixel circuits in the predetermined pixel circuit row from the data line by turning off the selection transistor in each of the pixel circuits in the predetermined pixel circuit row while a drive voltage of a drive transistor in each of pixel circuits in the pixel circuit row that is different from the predetermined pixel circuit row is set to the data line in the time period from the start to the completion of detecting a threshold voltage in each of the pixel circuits in the predetermined pixel circuit row.

22. A display device, as defined in claim 20, further comprising:
a constant voltage supply transistor for switching connection between the gate terminal of the drive transistor and a constant voltage source, the constant voltage supply transistor being provided parallel to the selection transistor with respect to the gate terminal of the drive transistor in each of the pixel circuits, wherein the threshold voltage detection unit turns off the selection transistor and turns on the constant voltage supply transistor to set a constant voltage from the constant voltage source to the drive transistor in each of the pixel circuits in the predetermined pixel circuit row while the threshold voltage detection unit detects the threshold voltage in the predetermined pixel circuit row, and wherein the drive voltage setting unit turns off the constant voltage supply transistor and turns on the selection transistor while the drive voltage setting unit sets the drive voltage to the drive transistor in each of the pixel circuits in the predetermined pixel circuit row.

23. A display device, as defined in claim 20, further comprising:
a constant voltage supply transistor that is provided parallel to the selection transistor with respect to the gate terminal of the drive transistor in each of the pixel circuits; and
a gate voltage storage capacitance element for supplying, through the constant voltage supply transistor, a constant voltage to the gate terminal of the drive transistor in each of the pixel circuits is provided, wherein the threshold voltage detection unit connects the data line and the gate voltage storage capacitance element to the gate terminal of the drive transistor in each of the pixel circuits in the predetermined pixel circuit row by turning on the selection transistor and the constant voltage supply transistor, and after then, the threshold voltage detection unit detects the threshold voltage in the predetermined pixel circuit row by turning off the selection transistor to disconnect the gate terminal of the drive transistor in each of the pixel circuits in the predetermined pixel circuit row from the data line and by keeping the constant voltage supply transistor in an ON state, and wherein the drive voltage setting unit turns off the constant voltage supply transistor and turns on the selection transistor while the drive voltage setting unit sets the drive voltage to the drive transistor in each of the pixel circuits in the predetermined pixel circuit row.

24. A display device, as defined in claim 22, a common scan line is provided as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

25. A display device, as defined in claim 23, a common scan line is provided as a first scan line for sending a first scan signal to an (N−1)th pixel circuit row to control on/off of the selection transistor in each of the pixel circuits in the (N−1)th pixel circuit row and a second scan line for sending a second scan signal to an N-th pixel circuit row to control on/off of the constant voltage supply transistor in each of the pixel circuits in the N-th pixel circuit row.

26. A display device, as defined in claim 20, wherein the threshold voltage detection unit controls the time period of detecting the threshold voltage in each of the pixel circuits in the predetermined pixel circuit row by adjusting a time period of a reset operation performed on each of the pixel circuits before detecting the threshold voltage.
